(19) United States
(12) Patent Application Publication
(10) Pub. No.: US 2025/0312687 A1
(43) Pub. Date: Oct. 9, 2025

(54) SPLICED PUZZLE TABLE

(71) Applicant: Xiaoling Che, Dangyang (CN)

(72) Inventors: Meng Zhang, Shenzhen (CN); Xiaoling Che, Dangyang (CN); Jinyan Duan, Shenzhen (CN)

(21) Appl. No.: 19/243,730

(22) Filed: Jun. 20, 2025

Related U.S. Application Data
(63) Continuation-in-part of application No. 18/959,712, filed on Nov. 26, 2024.
Application No. 18/959,712 is a continuation-in-part of application No. 18/783,453, filed on Jul. 25, 2024, now Pat. No. 12,377,343.
Application No. 18/783,453 is a continuation-in-part of application No. 17/829,359, filed on Jun. 1, 2022, now Pat. No. 12,104,744.
Application No. 17/829,359 is a continuation-in-part of application No. 18/748,158, filed on Jun. 20, 2024.
Application No. 18/748,158 is a continuation-in-part of application No. 18/736,862, filed on Jun. 7, 2024, now Pat. No. 12,220,648.
Application No. 18/736,862 is a continuation-in-part of application No. 18/737,905, filed on Jun. 7, 2024.
Application No. 18/959,712 is a continuation-in-part of application No. 18/732,602, filed on Jun. 3, 2024, now Pat. No. 12,186,676.
Application No. 18/732,602 is a continuation-in-part of application No. 17/829,359, filed on Jun. 1, 2022, now Pat. No. 12,104,744.
Application No. 17/829,359 is a continuation-in-part of application No. 18/748,158, filed on Jun. 20, 2024.
Application No. 18/748,158 is a continuation-in-part of application No. 17/829,359, filed on Jun. 1, 2022, now Pat. No. 12,104,744.
Application No. 17/829,359 is a continuation-in-part of application No. 18/235,416, filed on Aug. 18, 2023, now Pat. No. 12,059,631.
Application No. 18/235,416 is a continuation-in-part of application No. 18/235,896, filed on Aug. 21, 2023, now Pat. No. 12,048,885.
Application No. 18/235,896 is a continuation of application No. 18/530,402, filed on Dec. 6, 2023, now Pat. No. 12,053,709.
Application No. 18/530,402 is a continuation-in-part of application No. 18/541,685, filed on Dec. 15, 2023, now Pat. No. 12,042,740.
Application No. 18/959,712 is a continuation-in-part of application No. 18/736,862, filed on Jun. 7, 2024, now Pat. No. 12,220,648.
Application No. 18/736,862 is a continuation of application No. 18/235,896, filed on Aug. 21, 2023, now Pat. No. 12,048,885.
Application No. 18/235,896 is a continuation-in-part of application No. 17/829,359, filed on Jun. 1, 2022, now Pat. No. 12,104,744.
Application No. 18/959,712 is a continuation-in-part of application No. 18/737,905, filed on Jun. 7, 2024.
Application No. 18/737,905 is a continuation of application No. 18/235,896, filed on Aug. 21, 2023, now Pat. No. 12,048,885.
Application No. 18/235,896 is a continuation of application No. 18/235,416, filed on Aug. 18, 2023, now Pat. No. 12,059,631.
Application No. 18/235,416 is a continuation-in-part of application No. 17/829,359, filed on Jun. 1, 2022, now Pat. No. 12,104,744.
Application No. 17/829,359 is a continuation-in-part of application No. 18/541,685, filed on Dec. 15, 2023, now Pat. No. 12,042,740.
Application No. 18/959,712 is a continuation-in-part of application No. 18/956,131, filed on Nov. 22, 2024, now Pat. No. 12,330,073.
Application No. 18/956,131 is a continuation of application No. 18/732,602, filed on Jun. 3, 2024, now Pat. No. 12,186,676.
Application No. 18/732,602 is a continuation of application No. 18/541,685, filed on Dec. 15, 2023, now Pat. No. 12,042,740.
Application No. 18/541,685 is a continuation of application No. 17/505,587, filed on Oct. 19, 2021, now Pat. No. 11,890,551.
(63) Continuation-in-part of application No. 18/814,612, filed on Aug. 26, 2024.
Application No. 18/814,612 is a continuation of application No. 17/829,359, filed on Jun. 1, 2022, now Pat. No. 12,104,744.
(63) Continuation-in-part of application No. 18/761,350, filed on Jul. 2, 2024.
Application No. 18/761,350 is a continuation of application No. 18/737,905, filed on Jun. 7, 2024.
Application No. 18/737,905 is a continuation of application No. 18/736,862, filed on Jun. 7, 2024, now Pat. No. 12,220,648.
Application No. 18/736,862 is a continuation-in-part of application No. 18/541,685, filed on Dec. 15, 2023, now Pat. No. 12,042,740.
Application No. 18/541,685 is a continuation of application No. 18/235,896, filed on Aug. 21, 2023, now Pat. No. 12,048,885.
Application No. 18/235,896 is a continuation-in-part of application No. 17/505,587, filed on Oct. 19, 2021, now Pat. No. 11,890,551.
Application No. 18/761,350 is a continuation of application No. 18/235,416, filed on Aug. 18, 2023, now Pat. No. 12,059,631.
Application No. 18/235,416 is a continuation-in-part of application No. 17/505,587, filed on Oct. 19, 2021, now Pat. No. 11,890,551.
Application No. 17/505,587 is a continuation of application No. 17/829,359, filed on Jun. 1, 2022, now Pat. No. 12,104,744.
Application No. 18/761,350 is a continuation of application No. 17/829,359, filed on Jun. 1, 2022, now Pat. No. 12,104,744.
Application No. 18/736,862 is a continuation of application No. 18/235,416, filed on Aug. 18, 2023, now Pat. No. 12,059,631.
(63) Continuation-in-part of application No. 18/916,412, filed on Oct. 15, 2024, now abandoned.
Application No. 18/916,412 is a continuation-in-part of application No. 18/817,289, filed on Aug. 28, 2024, now abandoned.
(63) Continuation-in-part of application No. 18/938,325, filed on Nov. 6, 2024, now abandoned.
Application No. 18/938,325 is a continuation-in-part of application No. 18/817,289, filed on Aug. 28, 2024, now abandoned.
Application No. 18/817,289 is a continuation-in-part of application No. 18/736,862, filed on Jun. 7, 2024, now Pat. No. 12,220,648.
Application No. 18/736,862 is a continuation-in-part of application No. 18/541,685, filed on Dec. 15, 2023, now Pat. No. 12,042,740.
Application No. 18/916,412 is a continuation of application No. 17/829,359, filed on Jun. 1, 2022, now Pat. No. 12,104,744.
Application No. 17/829,359 is a continuation of application No. 18/732,602, filed on Jun. 3, 2024, now Pat. No. 12,186,676.
Application No. 18/235,416 is a continuation-in-part of application No. 17/829,359, filed on Jun. 1, 2022, now Pat. No. 12,104,744.
(63) Continuation-in-part of application No. 18/950,536, filed on Nov. 18, 2024.
Application No. 18/950,536 is a continuation-in-part of application No. 18/736,862, filed on Jun. 7, 2024, now Pat. No. 12,220,648.
Application No. 18/736,862 is a continuation-in-part of application No. 18/748,158, filed on Jun. 20, 2024.
Application No. 18/748,158 is a continuation-in-part of application No. 18/734,521, filed on Jun. 5, 2024, now Pat. No. 12,239,914.
Application No. 18/734,521 is a continuation-in-part of application No. 17/829,359, filed on Jun. 1, 2022, now Pat. No. 12,104,744.
Application No. 17/829,359 is a continuation-in-part of application No. 18/235,416, filed on Aug. 18, 2023, now Pat. No. 12,059,631.
Application No. 18/235,416 is a continuation-in-part of application No. 18/530,402, filed on Dec. 6, 2023, now Pat. No. 12,053,709.
Application No. 18/530,402 is a continuation of application No. 18/235,896, filed on Aug. 21, 2023, now Pat. No. 12,048,885.
Application No. 18/950,536 is a continuation-in-part of application No. 18/783,453, filed on Jul. 25, 2024, now Pat. No. 12,377,343.

(30) Foreign Application Priority Data
Sep. 26, 2021 (CN) 202111131554.1
Sep. 26, 2021 (CN) 202122334815.1
Jan. 28, 2022 (CN) 202210103787.9
Oct. 28, 2022 (CN) 202230717091.6
Jun. 13, 2023 (CN) 202330364018.X
Feb. 28, 2024 (CN) 202420292101.X
Apr. 18, 2024 (CN) 202430220715.2
Apr. 30, 2024 (CN) 202430254326.1
May 8, 2024 (CN) 202420991164.4
May 23, 2024 (CN) 202430309522.4
Jun. 19, 2024 (CN) 202430377406.6
Sep. 26, 2024 (CN) 202422359068.0
Sep. 26, 2024 (CN) 202430265926.8
Oct. 23, 2024 (CN) 202430668605.2
Nov. 11, 2024 (CN) 202422744898.5
Mar. 28, 2025 (CN) 202520585165.3

(51) Int. Cl. A63F 9/10; A47B 25/00; A63F 3/00

(52) U.S. Cl. CPC A63F 9/1044; A63F 3/00261; A47B 25/00; A63F 2003/00274; A63F 2003/00952

(57) ABSTRACT

A spliced puzzle table includes a table portion and a support structure, the table portion comprises at least two splicing panels, the at least two splicing panels are configured to be spliced together on a plane; the support structure is disposed on a bottom surface of the table portion, and is configured to drive the table portion to rotate or move.

### CROSS REFERENCE TO RELATED APPLICATIONS

The present application claims the priority of Chinese Patent Application No. 202520585165.3, filed on Mar. 28, 2025; Chinese Patent Application No. 202422744898.5, filed on Nov. 11, 2024; Chinese patent application No. 202111131554.1 filed on Sep. 26, 2021; Chinese patent application No. 202122334815.1 filed on Sep. 26, 2021; Chinese patent application No. 202210103787.9 filed on Jan. 28, 2022; Chinese patent application No. 202330364018.X filed on Jun. 13, 2023; Chinese patent application No. 202420292101.X filed on Feb. 28, 2024; Chinese patent application No. 202430220715.2 filed on Apr. 18, 2024; Chinese patent application No. 202430254326.1 filed on Apr. 30, 2024; Chinese patent application No. 202430309522.4 filed on May 23, 2024; Chinese patent application No. 202430377406.6 filed on Jun. 19, 2024; Chinese patent application No. 202230717091.6 filed on Oct. 28, 2022; Chinese patent application No. 202420991164.4 filed on May 8, 2024; Chinese patent application No. 202430265926.8 filed on Sep. 26, 2024; Chinese patent application No. 202422359068.0 filed on Sep. 26, 2024; Chinese patent application No. 202430668605.2 filed on Oct. 23, 2024, the contents of each of which are incorporated by reference in their entirety.

This application is a continuation-in-part application of: U.S. patent application Ser. No. 18/959,712 filed on Nov. 26, 2024; U.S. patent application Ser. No. 18/814,612 filed on Aug. 26, 2024; U.S. patent application Ser. No. 18/761,350 filed on Jul. 2, 2024; U.S. patent application Ser. No. 18/916,412 filed on Oct. 15, 2024; U.S. patent application Ser. No. 18/938,325 filed on Nov. 6, 2024; and U.S. patent application Ser. No. 18/950,536 filed on Nov. 18, 2024.

The U.S. patent application Ser. No. 18/959,712 is a continuation-in-part of U.S. patent application Ser. No. 18/783,453, filed on Jul. 25, 2024, which is a continuation-in-part of U.S. patent application Ser. No. 17/829,359 filed on Jun. 1, 2022, now U.S. Pat. No. 12,104,744 issued on Oct. 1, 2024 and a continuation-in-part of U.S. patent application Ser. No. 18/748,158 filed on Jun. 20, 2024 and a continuation-in-part of U.S. patent application Ser. No. 18/736,862 filed on Jun. 7, 2024, now U.S. patent Ser. No. 12,220,648 issued on Feb. 11, 2025 and a continuation-in-part of U.S. patent application Ser. No. 18/737,905 filed on Jun. 7, 2024; a continuation-in-part of U.S. patent application Ser. No. 18/732,602 filed on Jun. 3, 2024, now U.S. Pat. No. 12,186,676 issued on Jan. 7, 2025; a continuation-in-part of U.S. patent application Ser. No. 17/829,359 filed on Jun. 1, 2022, now U.S. Pat. No. 12,104,744 issued on Oct. 1, 2024; a continuation-in-part of U.S. patent application Ser. No. 18/748,158, filed on Jun. 20, 2024, which is a continuation-in-part of U.S. patent application Ser. No. 17/829,359 filed on Jun. 1, 2022, now U.S. Pat. No. 12,104,744 issued on Oct. 1, 2024 and a continuation-in-part of U.S. patent application Ser. No. 18/235,416 filed on Aug. 18, 2023, now U.S. patent Ser. No. 12,059,631 issued on Aug. 13, 2024 and a continuation-in-part of U.S. patent application Ser. No. 18/235,896 filed on Aug. 21, 2023, now U.S. Pat. No. 12,048,885, issued on Jul. 30, 2024 and a continuation of U.S. patent application Ser. No. 18/530,402 filed on Dec. 6, 2023, now U.S. Pat. No. 12,053,709 issued on Aug. 6, 2024 and a continuation-in-part of U.S. patent application Ser. No. 18/541,685 filed on Dec. 15, 2023, now U.S. Pat. No. 12,042,740 issued on Jul. 23, 2024; a continuation-in-part of U.S. patent application Ser. No. 18/736,862, filed on Jun. 7, 2024, which is a continuation of U.S. patent application Ser. No. 18/235,896 filed on Aug. 21, 2023, now U.S. Pat. No. 12,048,885 issued on Jul. 30, 2024, which is a continuation-in-part of U.S. patent application Ser. No. 17/829,359 filed on Jun. 1, 2022, now U.S. Pat. No. 12,104,744 issued on Oct. 1, 2024; a continuation-in-part of U.S. patent application Ser. No. 18/737,905, filed on Jun. 7, 2024, which is a continuation of U.S. patent application Ser. No. 18/235,896 filed on Aug. 21, 2023, now U.S. Pat. No. 12,048,885, issued on Jul. 30, 2024 and a continuation of U.S. patent application Ser. No. 18/235,416 filed on Aug. 18, 2023, now U.S. patent Ser. No. 12,059,631 issued on Aug. 13, 2024 and a continuation-in-part of U.S. patent application Ser. No. 17/829,359 filed on Jun. 1, 2022, now U.S. Pat. No. 12,104,744 issued on Oct. 1, 2024 and a continuation-in-part of U.S. patent application Ser. No. 18/541/685 filed on Dec. 15, 2023, now U.S. Pat. No. 12,042,740 issued on Jul. 23, 2024; a continuation-in-part of U.S. patent application Ser. No. 19/005,568 filed on Dec. 30, 2024, which is a continuation of U.S. patent application Ser. No. 18/736,862, filed on Jun. 7, 2024 and a continuation-in-part of U.S. patent application Ser. No. 17/829,359 filed on Jun. 1, 2022, now U.S. Pat. No. 12,104,744 issued on Oct. 1, 2024; a continuation-in-part of U.S. patent application Ser. No. 18/956,131 filed on Nov. 22, 2024, which is a continuation of U.S. patent application Ser. No. 18/732,602 filed on Jun. 3, 2024, now U.S. Pat. No. 12,186,676 issued on Jan. 7, 2025; and a continuation-in-part of U.S. patent application Ser. No. 18/732,602, filed on Jun. 3, 2024, now U.S. Pat. No. 12,186,676 issued on Jan. 7, 2025, which is a continuation of U.S. patent application Ser. No. 18/541,685 filed on Dec. 15, 2023, now U.S. Pat. No. 12,042,740 issued on Jul. 23, 2024, which is a continuation of U.S. patent application Ser. No. 17/505,587 filed on Oct. 19, 2021, now U.S. patent Ser. No. 11,890,551, issued on Feb. 6, 2024.

The U.S. patent application Ser. No. 18/814,612 is a continuation of U.S. patent application Ser. No. 17/829,359 filed on Jun. 1, 2022, now U.S. Pat. No. 12,104,744, issued on Oct. 1, 2024.

The U.S. patent application Ser. No. 18/761,350 is a continuation of U.S. patent application Ser. No. 18/737,905 filed on Jun. 7, 2024; a continuation of U.S. patent application Ser. No. 18/736,862 filed on Jun. 7, 2024; a continuation-in-part of U.S. patent application Ser. No. 18/541,685 filed on Dec. 15, 2023, now U.S. Pat. No. 12,042,740 issued on Jul. 23, 2024, which is a continuation of U.S. patent application Ser. No. 17/505,587 filed on Oct. 19, 2021, now U.S. patent Ser. No. 11,890,551, issued on Feb. 6, 2024; a continuation of U.S. patent application Ser. No. 18/235,896 filed on Aug. 21, 2023, now U.S. Pat. No. 12,048,885, issued on Jul. 30, 2024, which is a continuation-in-part of U.S. patent application Ser. No. 17/505,587 filed on Oct. 19, 2021, now U.S. patent Ser. No. 11,890,551, issued on Feb. 6, 2024 and a continuation-in-part of U.S. patent application Ser. No. 17/829,359 filed on Jun. 1, 2022, now U.S. Pat. No. 12,104,744 issued on Oct. 1, 2024; a continuation of U.S. patent application Ser. No. 18/235,416 filed on Aug. 18, 2023, now U.S. patent Ser. No.12,059,631 issued on Aug. 13, 2024, which is a continuation-in-part of U.S. patent application Ser. No. 17/505,587 filed on Oct. 19, 2021, now U.S. patent Ser. No. 11,890,551, issued on Feb. 6, 2024 and a continuation of U.S. patent application Ser. No. 17/829,359 filed on Jun. 1, 2022, now U.S. Pat. No. 12,104,744 issued on Oct. 1, 2024; a continuation of U.S. patent application Ser. No. 17/829,359 filed on Jun. 1, 2022, now U.S. Pat. No.12,104,744 issued on Oct. 1, 2024. The U.S. patent application Ser. No. 18/736,862 is a continuation of U.S. patent application Ser. No. 18/235,416 filed on Aug. 18, 2023, now U.S. patent Ser. No. 12,059,631 issued on Aug. 13, 2024.

The U.S. patent application Ser. No. 18/916,412 and No. 18/938,325 are continuation-in-part of U.S. patent application Ser. No. 18/817,289 filed on Aug. 28, 2024. The U.S. patent application Ser. No. 18/817,289 is a continuation-in-part of U.S. patent application Ser. No. 18/736,862 filed on Jun. 7, 2024, now U.S. patent Ser. No. 12,220,648 issued on Feb. 11, 2025, which is a continuation of U.S. patent application Ser. No. 18/235,896 filed on Aug. 21, 2023, now U.S. Pat. No. 12,048,885, issued on Jul. 30, 2024 and a continuation of U.S. patent application Ser. No. 18/235,416 filed on Aug. 18, 2023, now U.S. patent Ser. No. 12,059,631 issued on Aug. 13, 2024 and a continuation-in-part of U.S. patent application Ser. No. 18/541,685 filed on Dec. 15, 2023, now U.S. Pat. No. 12,042,740 issued on Jul. 23, 2024 and a continuation-in-part of U.S. patent application Ser. No. 17/829,359 filed on Jun. 1, 2022, now U.S. Pat. No. 12,104,744 issued on Oct. 1, 2024; a continuation of U.S. patent application Ser. No. 17/829,359 filed on Jun. 1, 2022, now U.S. Pat. No. 12,104,744 issued on Oct. 1, 2024 and a continuation of U.S. patent application Ser. No. 18/732,602 filed on Jun. 3, 2024, now U.S. Pat. No. 12,186,676 issued on Jan. 7, 2025. The U.S. patent application Ser. No. 18/235,896 is a continuation-in-part of U.S. patent application Ser. No. 17/505,587 filed on Oct. 19, 2021, now U.S. patent Ser. No. 11,890,551, issued on Feb. 6, 2024. The U.S. patent application Ser. No. 18/235,416 is a continuation-in-part of U.S. patent application Ser. No. 17/505,587 filed on Oct. 19, 2021, now U.S. patent Ser. No. 11,890,551, issued on Feb. 6, 2024 and a continuation-in-part of U.S. patent application Ser. No. 17/829,359 filed on Jun. 1, 2022, now U.S. Pat. No. 12,104,744 issued on Oct. 1, 2024. The U.S. patent application Ser. No. 18/235,896 is a continuation-in-part of U.S. patent application Ser. No. 17/829,359 filed on Jun. 1, 2022, now U.S. Pat. No. 12,104,744 issued on Oct. 1, 2024.

The U.S. patent application Ser. No. 18/950,536 is a continuation-in-part of U.S. patent application Ser. No. 18/736,862 filed on Jun. 7, 2024, now U.S. patent Ser. No. 12,220,648 issued on Feb. 11, 2025; a continuation-in-part of U.S. patent application Ser. No. 18/748,158 filed on Jun. 20, 2024; a continuation-in-part of U.S. patent application Ser. No. 18/734,521 filed on Jun. 5, 2024, now U.S. Pat. No. 12,239,914 issued on Mar. 4, 2025, which is a continuation-in-part of U.S. patent application Ser. No. 17/829,359 filed on Jun. 1, 2022, now U.S. Pat. No. 12,104,744 issued on Oct. 1, 2024 and a continuation-in-part of U.S. patent application Ser. No. 18/235,416 filed on Aug. 18, 2023, now U.S. patent Ser. No. 12,059,631 issued on Aug. 13, 2024 and a continuation-in-part of U.S. patent application Ser. No. 18/530,402 filed on Dec. 6, 2023, now U.S. Pat. No. 12,053,709 issued on Aug. 6, 2024 and a continuation of U.S. patent application Ser. No. 18/235,896 filed on Aug. 21, 2023, now U.S. Pat. No. 12,048,885, issued on Jul. 30, 2024; a continuation-in-part of U.S. patent application Ser. No. 18/783,453 filed on Jul. 25, 2024. The contents of each of which are incorporated by reference in their entirety.

### FIELD

The present disclosure relates to the field of puzzle tables, and particularly to a spliced puzzle table.

### BACKGROUND

As an educational game, puzzles play an important role in children's intellectual development. In order to assist users in assembling puzzles, puzzle tables have been introduced, which provide a dedicated surface for placing puzzles. The puzzle tables in the art generally have flat boards, flat boards can occupy a large space, causing high costs in packaging and transportation, and is inconvenient for storage.

### SUMMARY

A spliced puzzle table includes a table portion and a support structure, the table portion includes at least two splicing panels, the at least two splicing panels are configured to be spliced together on a plane; the support structure is disposed on a bottom surface of the table portion, and is configured to drive the table portion to rotate or move.

### BRIEF DESCRIPTION OF THE DRAWINGS

To provide a clearer illustration of the technical solutions in the embodiments of the present disclosure or in the prior art, a brief introduction will be given to the drawings used in the description of the embodiments or the prior art. It is obvious that the drawings described below are merely some embodiments of the present disclosure, and for those skilled in the art, other drawings can be obtained based on these drawings without creative efforts.

FIG. 1 is a schematic view of a spiced puzzle table according to an embodiment, showing the table portion having three sub-portions.

FIG. 2 is a second schematic view of a spiced puzzle table according to an embodiment, showing the table portion having four sub-portions.

FIG. 3 is a third schematic view of a spiced puzzle table according to an embodiment, showing the table portion having three sub-portions.

FIG. 4 is a schematic view according to an embodiment, showing the bottom surface structure of the table portion.

FIG. 5 is a second schematic view according to an embodiment, showing the bottom surface structure of the table portion.

FIG. 6 is a third schematic view according to an embodiment, showing the bottom surface structure of the table portion.

FIG. 7 is a fourth schematic view according to an embodiment, showing the bottom surface structure of the table portion.

FIG. 8 is a schematic view according to an embodiment, showing the table portion having four sub-portions.

FIG. 9 is a schematic view according to two embodiments, each having four sub-portions.

FIG. 10 is a schematic view according to an embodiment, showing the structure of the three splicing panels that make up the three sub-portions of the table portion.

FIG. 11 is a schematic view according to an embodiment, showing the structure of the four splicing panels that make up the four sub-portions of the table portion.

FIG. 12 is a schematic view according to an embodiment, showing the structure of six splicing panels that make up the three sub-portions of the table portion.

FIG. 13 is a schematic view according to an embodiment, showing the splicing effect of the three splicing panels.

FIG. 14 is a second schematic view according to an embodiment, showing the splicing effect of the three splicing panels.

FIG. 15 is a schematic view according to an embodiment, showing the bottom surface structure of a splicing panel.

FIG. 16 is a schematic view according to an embodiment, showing the upper surface of a splicing panel.

FIG. 17 is a schematic cross, sectional view of the connecting assembly according to an embodiment, showing the embedding portion and embedding platform are engaged via a snap hook.

FIG. 18 is a schematic view of an installation structure between the roller component and the fixing boss according to an embodiment.

FIG. 19 is a exploded schematic view of the rotating support.

FIG. 20 is a schematic view of the support structure according to an embodiment, showing the support structure is configured as multiple universal wheels.

FIG. 21 is a schematic view according to an embodiment, showing the connection structure between the universal wheels and the splicing panel.

FIG. 22 is a schematic view according to an embodiment, where a bottom plate is installed at the bottom of the table portion, and the support structure includes multiple universal wheels.

FIG. 23 is a schematic view according to Embodiment 1.

FIG. 24 is a schematic view according to Embodiment 2.

FIG. 25 is a schematic view according to Embodiment 3.

FIG. 26 is a schematic view according to Embodiment 4.

FIG. 27 is a schematic view according to Embodiment 5.

FIG. 28 is a schematic view according to Embodiment 6.

FIG. 29 is a schematic view according to Embodiment 7.

FIG. 30 is a schematic view according to Embodiment 8.

FIG. 31 is a schematic view according to Embodiment 9.

FIG. 32 is a schematic view according to Embodiment 10.

FIG. 33 is a schematic view according to Embodiment 11.

FIG. 34 is a schematic view according to Embodiment 12.

### REFERENCE NUMERALS IN THE DRAWINGS

10, table portion; 11, splicing panel; 12, sub-portion; 121, first sub-portion; 122, second sub-portion; 123, third sub-portion; 124, fourth sub-portion; 101, bottom surface; 102, gravity center; 103, corner of table portion; 111, top plate; 112, fixing boss; 113, reinforcing ribs; 1120, hollow slot; 1121, connecting post; 1122, sliding rail structure; 1123, sliding groove;
20, support structure; 21, roller component; 211, mounting base; 212, ball; 22, rotating support; 221, fixing base; 222, rotating member; 223, rolling ball; 224, ball-connecting member; 2201, first ring; 2202, second ring;
30, drawer;
40, base plate;
50, connecting assembly; 51, first connecting member; 52, second connecting member; 512, embedding platform; 513, latching hole; 514, insertion seam; 522, embedding portion; 523, embedding slot; 524, insertion plate; 525, latching hook.

### DETAILED DESCRIPTION

Unless otherwise defined, all technical and scientific terms used herein have the same meaning as commonly understood by those skilled in the art to which this disclosure belongs. The terms used in the description of the application herein are intended for describing particular embodiments only and are not intended to limit the present disclosure. In the description, claims, and the above drawings of the present disclosure, the terms “comprising” and “having”, as well as their variants, are intended to convey a non, exclusive inclusion. The terms “first”, “second”, etc., as used herein, are intended to distinguish between different objects, rather than to describe a particular order.

Reference to “embodiments” herein implies that a particular feature, structure, or characteristic described in connection with an embodiment may be included in at least one embodiment of the present disclosure. The appearance of the phrase at various places in the specification does not necessarily refer to the same embodiment, nor is it a separate or alternative embodiment that is mutually exclusive of other embodiments. One skilled in the art would explicitly and implicitly understand that the embodiments described herein can be combined with other embodiments.

In order to enable those skilled in the art to better understand the technical solutions of the present disclosure, the technical solutions in the embodiments of the present disclosure will be clearly and completely described below with reference to the accompanying drawings.

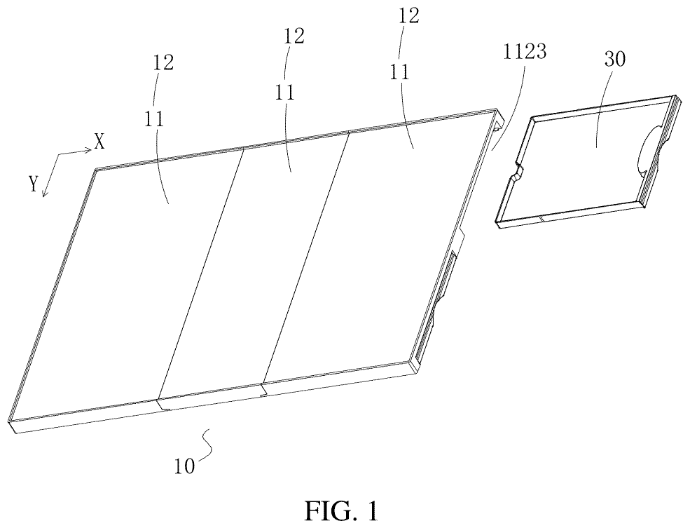

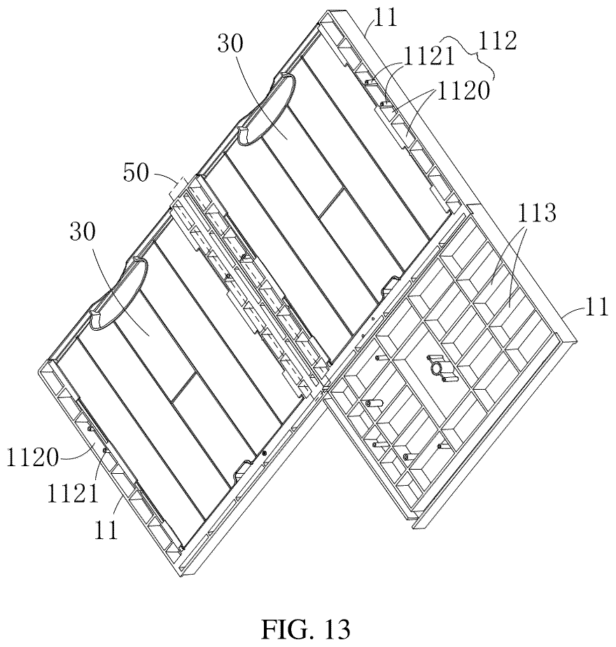

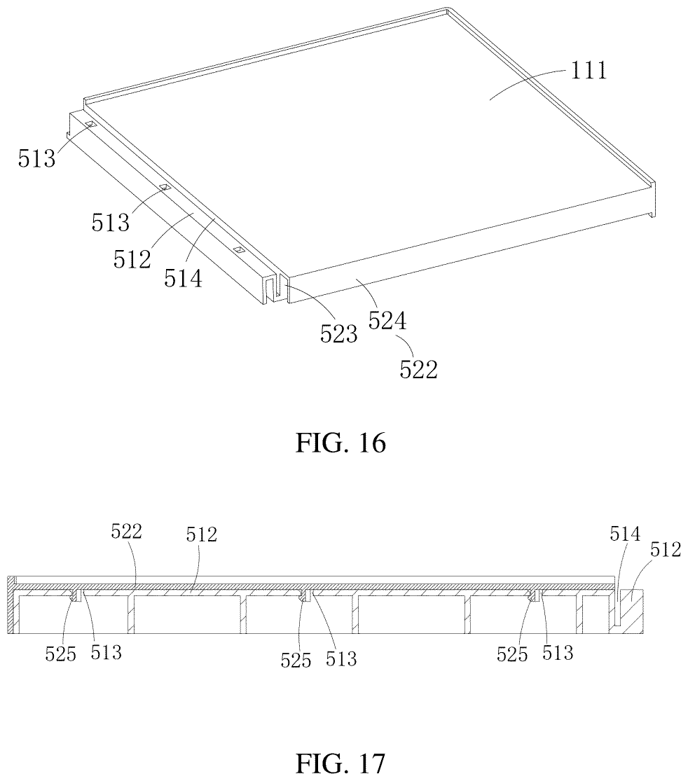

As shown in FIG. 1 to FIG. 34, the present disclosure provides a spliced puzzle table, including a table portion 10 and a support structure 20. The support structure 20 is disposed on a bottom surface 101 of the table portion 10 and is configured to drive the table portion 10 to rotate or move. The table portion 10 includes at least two splicing panels 11, the at least two splicing panels 11 are configured to be spliced together on a plane. When the at least two splicing panels 11 are spliced together, an upper surface of the table portion 10 is flat and remains horizontal. For example, the table portion 10 may include three, four, or six splicing panels 11, when packaging and transporting, the table portion 10 can be disassembled into a plurality of splicing panels 11, such that a space occupied by the table portion 10 can be reduced.

In some embodiments, to ensure that the table portion 10 is capable of withstanding forces uniformly, the support structure 20 substantially surrounds a gravity center 102 of the table portion 10 in a uniform or non uniform layout. The support structure 20 and the bottom surface 101 of the table portion 10 are connected with each other via at least one of adhesive bonding, snap, fit connection, magnetic attraction, bolted connection, or pinned connection. It should be clarified that other connections can also be applied to connect the support structure 20 and the bottom surface 101 of the table portion 10.

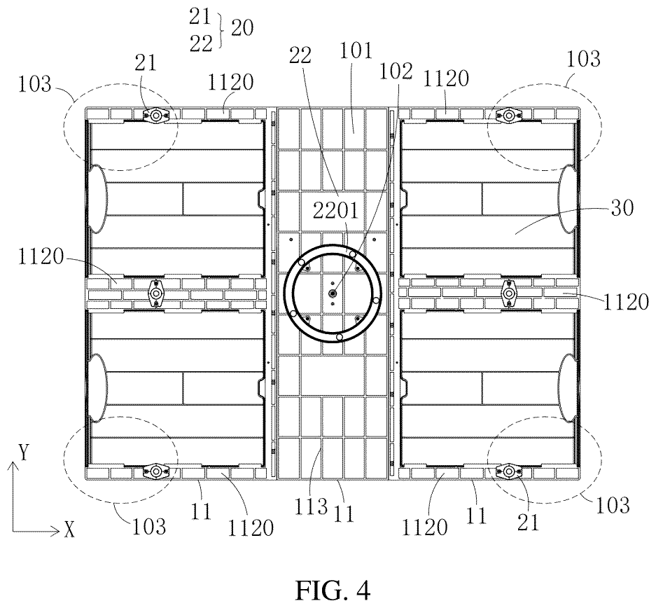

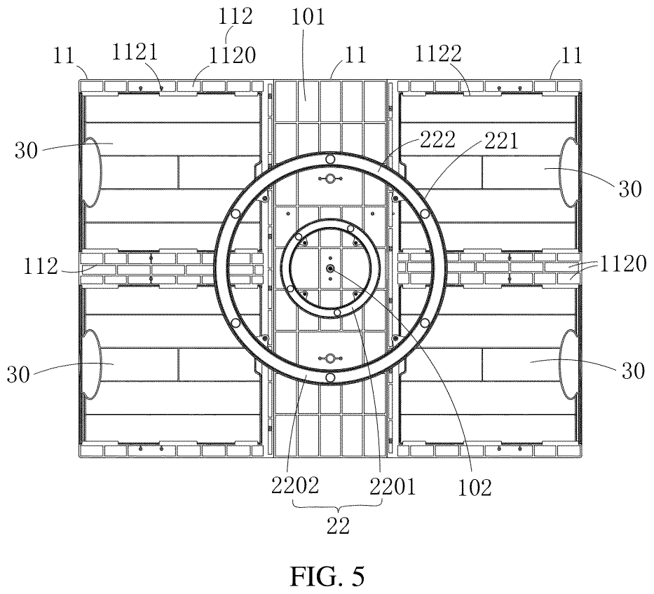

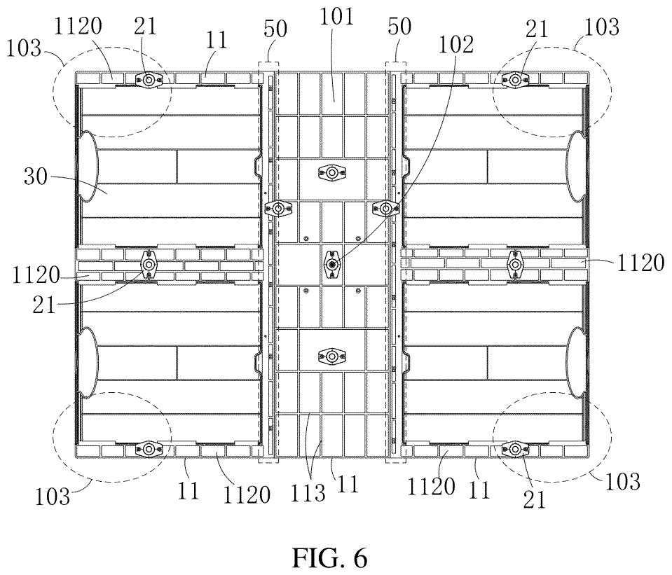

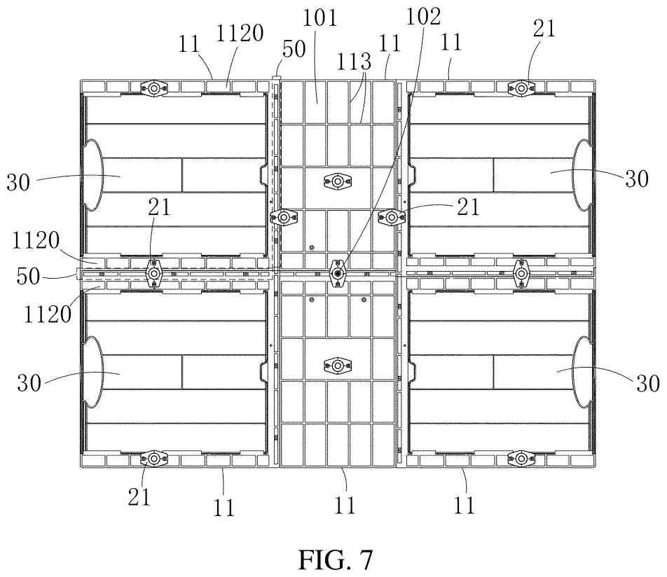

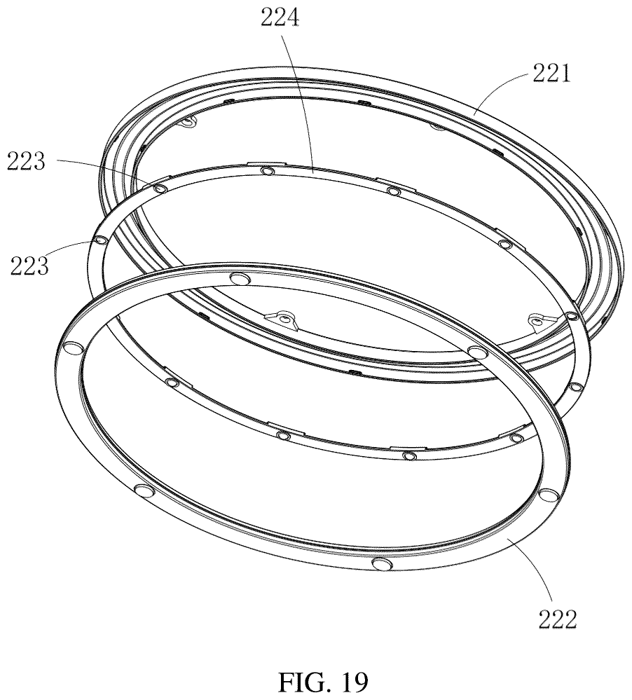

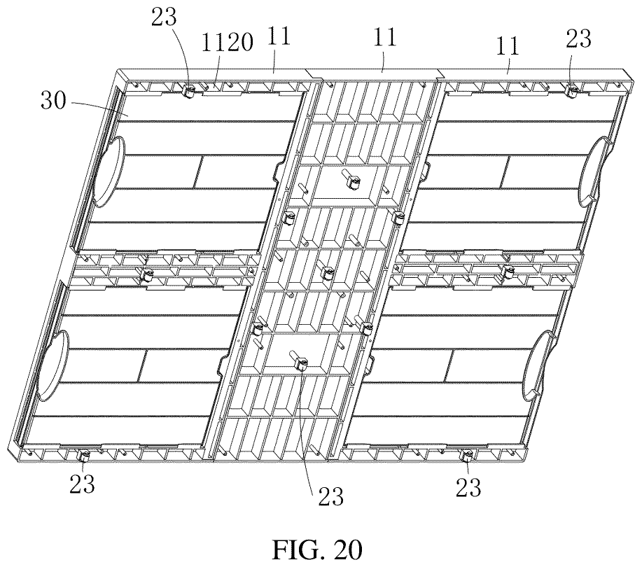

Regarding the structure of the support structure 20, a plurality of roller components 21, as shown in FIG. 6 and FIG. 7, can be served as the support structure 20. Alternatively, a rotating support 22, as shown in FIG. 5 and FIG. 19, or at least one universal wheel 23, as shown in FIG. 20 to FIG. 22, can be served as the support structure 20. In addition, a combination of the roller component 21, the rotating support 22, and the universal wheel 23 can also be employed, such as a combination of the roller component 21 and the rotating support 22 as shown in FIG. 4.

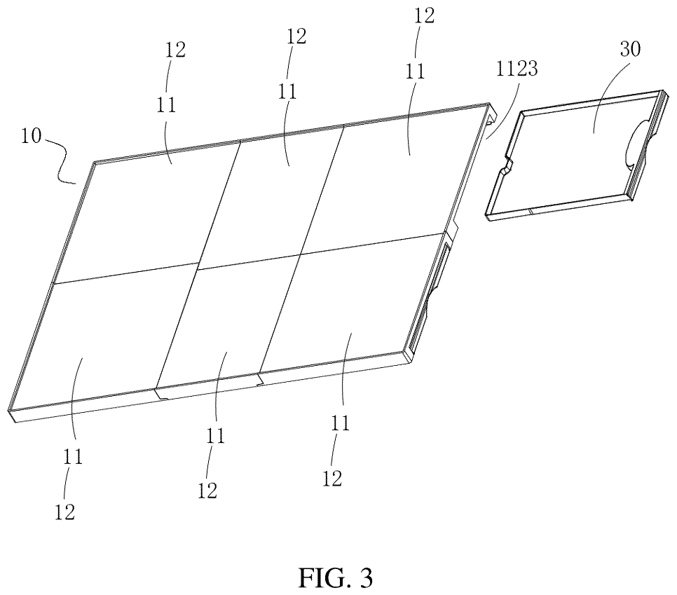

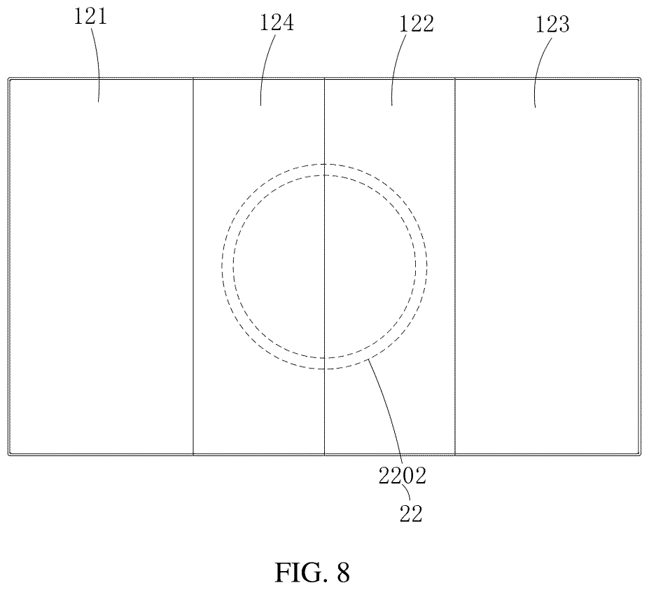

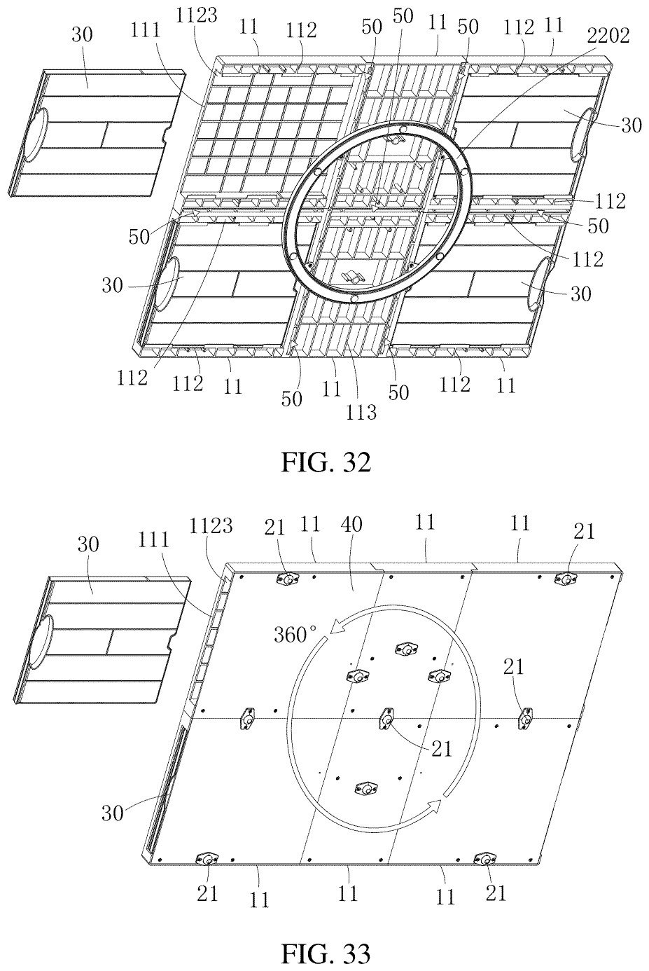

In some embodiments, regarding the splicing layout of the table portion 10, the table portion 10 includes at least three sub-portions 12, which are defined as a first sub-portion 121, a second sub-portion 122, and a third sub-portion 123. The first sub-portion 121, the second sub-portion 122, and the third sub-portion 123 are configured to be aligned to each other along one straight line. Each sub-portion 12 of the at least three sub-portions 12 includes at least one splicing panel 11, a length and a width of each splicing panel 11 may be identical to or different from that of another splicing panel 11. The length described above or below refer to a length direction X of the table portion 10, and the width described above or below refer to a width direction Y of the table portion 10, as illustrated in FIG. 1 and FIG. 4. The support structure 20 is mounted on at least one sub-portion 12. In an embodiment, as shown in FIG. 1 and FIG. 24, the table portion 10 includes only the first sub-portion 121, the second sub-portion 122, and the third sub-portion 123. The support structure 20 is embodied as a rotating support 22, and the rotating support 22 is mounted only on the second sub-portion 122. In another embodiment, as shown in FIG. 3 and FIG. 32, the table portion 10 includes only the first sub-portion 121, the second sub-portion 122, and the third sub-portion 123. A rotating support 22 is configured to serve as the support structure 20, and the rotating support 22 extends across the second sub-portion 122 and is connected to the first sub-portion 121 and the third sub-portion 123. Moreover, in other embodiments, as shown in FIG. 8, the table portion 10 includes four sub-portions 12 connected in sequence, including the first sub-portion 121, the third sub-portion 123, a fourth sub-portion 124, and the second sub-portion 122. The fourth sub-portion 124 is located between the first sub-portion 121 and the second sub-portion 122, and the second sub-portion 122 is located between the fourth sub-portion 124 and the third sub-portion 123. The support structure 20 is embodied as a rotating support 22, and the rotating support 22 is connected to the second sub-portion 122 and the fourth sub-portion 124.

In addition, each sub-portion 12 can includes one or two splicing panels 11, or even more splicing panels 11. The number of splicing panels 11 of each sub-portion 12 may be identical or different. As shown in FIG. 1, each sub-portion 12 has only one splicing panel 11. As shown in FIG. 3, each sub-portion 12 has two splicing panels 11.

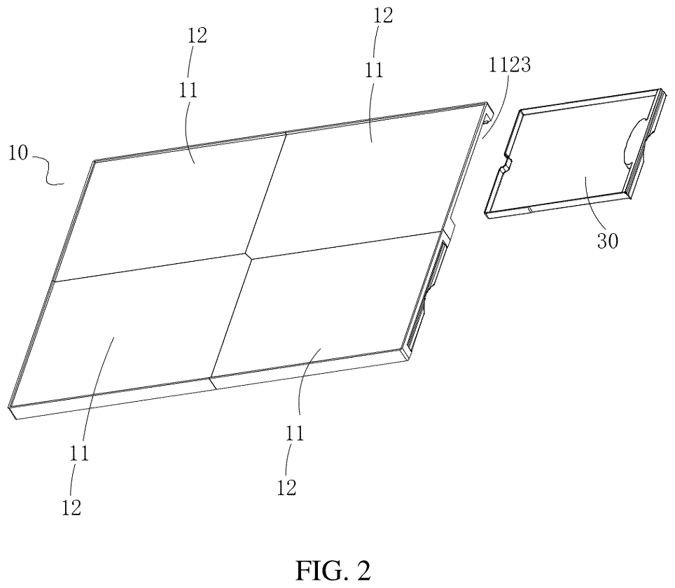

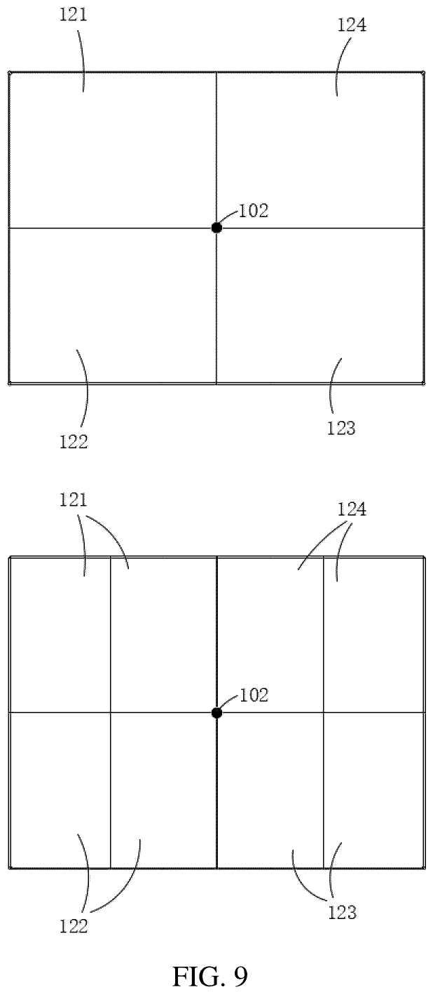

Regarding the splicing layout of the table portion 10, in another embodiment, as illustrated in FIG. 2 and FIG. 9, the table portion 10 includes a first sub-portion 121, a second sub-portion 122, a third sub-portion 123, and a fourth sub-portion 124. The first sub-portion 121, second sub-portion 122, third sub-portion 123, and fourth sub-portion 124 are arranged in four directions around the gravity center 102 of the table portion 10. The support structure 20 is a rotating support 22, the rotating support 22 is arranged around the gravity center 102 of the table portion 10 and is connected to all of the first sub-portion 121, the second sub-portion 122, the third sub-portion 123, and the fourth sub-portion 124. In this case, each sub-portion 12 includes at least one splicing panel 11. In an embodiment, the table portion 10 may be configured as a circular structure, the table portion 10 includes at least three sub-portions 12, the at least three sub-portions 12 are arranged circumferentially around the gravity center 102 of the table portion 10, this embodiment is not illustrated in the drawings.

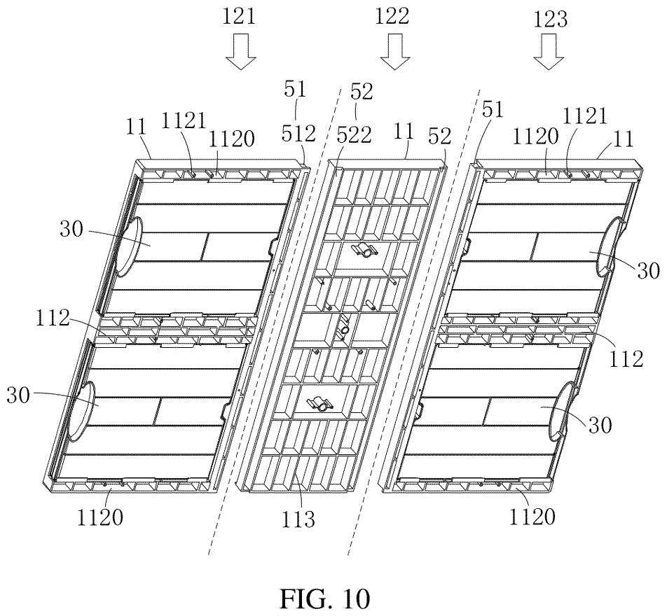

Regarding the structure of the splicing panel 11, in an embodiment, the table portion 10 includes at least two splicing panels, each splicing panel 11 includes a top plate 111 and at least two fixing bosses 112, the at least two fixing bosses 112 are formed below edges of the top plate 111. The at least two fixing bosses 112 are parallel with each other. The structure of the splicing panel 11 can be understood with reference to FIG. 10 to FIG. 16. A drawer 30 can be mounted on the at least two fixing bosses 112 by a user. For example, a sliding rail structure 1122 is formed on the fixing boss 112, and the sliding rail structures 1122 of at least two fixing bosses 112 together define a sliding groove 1123 for guiding the drawer 30 to slide along a longitudinal direction of the fixing bosses 112. After the at least two splicing panels 11 are spliced together, at least two top plates 111 of the at least two splicing panels 11 are aligned to each other. In other embodiments, some of the splicing panels 11 may only include the top plate 111. For example, as shown in FIG. 10, three splicing panels 11 are arranged along one straight line to form the table portion 10, two splicing panels 11 on two sides of the table portion 10 each includes the top plate 111 and the fixing bosses 112, and the splicing panel 11 in the middle includes only the top plate 111. A plurality of reinforcing ribs 113 can be arranged on a bottom surface of the top plate 111. In another word, in this case, only the two splicing panels on two sides of the table portion 10 are arranged with the drawers 30.

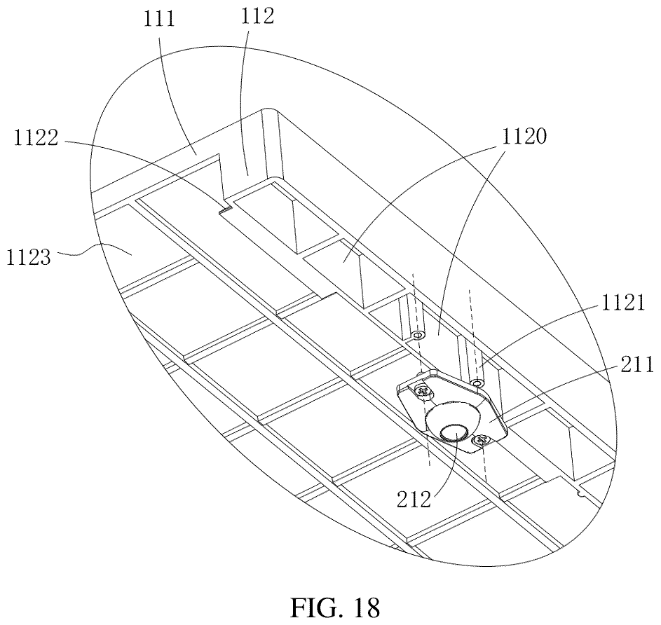

As for the structure of the support structure 20, in an embodiment, as shown in FIG. 6 and FIG. 18, the support structure 20 includes a plurality of roller components 21. Each roller component 21 comprises a mounting base 211 and a ball 212 mounted on the mounting base 211, and the ball is capable of rolling within the mounting base 211, the mounting base 211 of the roller component 21 is fixedly connected to the bottom surface 101 of the table portion 10, and the ball 212 is in contact with a flat surface such as a ground. As shown in FIG. 33, the plurality of roller components 21 are configured to support the table portion 10 to perform 360-degree rotation or planar translation in any direction. When pushing the table portion 10, movement of the table portion 10 causes the ball 212 to roll, such that the friction applied to the table portion 10 can be reduced.

The plurality of roller components 21 may be mounted at any location of the bottom surface of the table portion 10, or be mounted below the drawer 30. However, to provide more stable support for the table portion 10 and to prevent the table portion 10 from being affected by movement of the drawer 30, in some embodiments, some roller components 21 are mounted at fixing bosses 112 of the splicing panels 11 and/or at edges of the splicing panels 11, while avoiding mounting the roller components 21 beneath the drawer 30.

In some embodiments, regarding the connection structure between the mounting base 211 and the fixing boss 112, as shown in FIG. 18, a hollow slot 1120 is defined at a bottom of the fixing boss 112. A connecting post 1121 is arranged within the hollow slot 1120 and extends downward. The connecting post 1121 is connected to the mounting base 211 via bolts or pins. The hollow slot 1120 facilitates reducing material cost and a weight of the splicing panel 11. On this basis, a threaded hole is defined within the connecting post 1121 to receive a bolt from the mounting base 211, in addition, the connecting post 1121 can also provide a longer connecting length between the bolt and the fixing boss 112.

In an embodiment, the table portion 10 is configured as a rectangular structure. As shown in FIG. 6, at least four roller components 21 are arranged at the fixing bosses 112 located at four corners 103 of the table portion 10, and each of the four corners has at least one roller component 21. A four point support structure can prevent the table portion 10 from tilting. To avoid collapse due to stress concentration at a central portion of the table portion 10, a plurality of roller components 21 may also be arranged at the central portion of the table portion 10. The central portion of the table portion 10 refers to a region excluding an edge portion and an area where the drawer 30 is mounted.

As shown in FIG. 7, at least one mounting base 211 connects two adjacent splicing panels 11 to enhance the connection strength between the two adjacent splicing panels 11. In this case, the connection between two adjacent splicing panels 11 is reinforced, therefore, the gap between two adjacent splicing panels 11 can be prevented from becoming larger, and disconnection between two adjacent splicing panels 11 can also be avoided. A plurality of roller components 21 may be distributed in a layout as shown in FIG. 4 or FIG. 7.

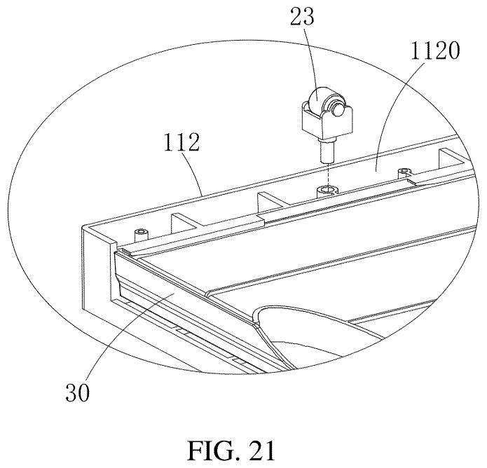

As for the support structure 20, in an embodiment, as shown in FIG. 20 and FIG. 21, the support structure 20 includes a plurality of universal wheels 23. The universal wheels 23 may be connected to and mounted on the table portion 10 in a same manner as the roller components 21 described above. In other words, the roller components 21 in the above embodiments may be replaced by the universal wheels 23. The universal wheels 23 may be fixed on the splicing panels 11 by an insertion structure as shown in FIG. 21, or alternatively, by screws, adhesive bonding, or other fastening methods. In order to simplify the description, detailed illustration of the universal wheels 23 is omitted.

As for the support structure 20, in another embodiment, the support structure 20 includes at least one rotating support 22. As shown in FIG. 19, each rotating support 22 includes a fixing base 221 and a rotating member 222, the rotating member 222 is able to rotate relative to the fixing base 221. The rotating member 222 is able to rotate 360 degrees relative to the fixing base 221. A plurality of rolling balls 223 are clamped between the fixing base 221 and the rotating member 222. In some embodiments, a ball-connecting member 224 may be provided to connect the plurality of rolling balls 223, such that each rolling ball 223 can rotate on the ball-connecting member 224, and the plurality of rolling balls 223 can be retained at intervals by the ball-connecting member 224. The fixing base 221 of the rotating support 22 is fixed to the bottom surface 101 of the table portion 10, and the rotating member 222 is in contact with the ground to provide support. To enhance stability, the rotating support 22 is configured to surround the gravity center 102 of the table portion 10 such that a rotation axis of the rotating member 222 is aligned with the gravity center 102 of the table portion 10. The rotation axis of the rotating member 222 may also be slightly offset from the gravity center 102, which has little effect on a supporting performance of the rotating support 22.

A size of the rotating support 22 may be mated with the layout of the splicing panels 11. As shown in FIG. 1 and FIG. 24, in an embodiment, the table portion 10 includes a first sub-portion 121, a second sub-portion 122, and a third sub-portion 123. The first sub-portion 121, the second sub-portion 122, and the third sub-portion 123 are arranged in sequence along one straight line and are aligned to each other. Each of the first sub-portion 121, the second sub-portion 122, and the third sub-portion 123 includes one splicing panel 11. At least one rotating support 22 includes a first ring 2201 with small size. The first ring 2201 includes an annular fixing base 221, an annular rotating member 222, a plurality of rolling balls 23 and a ball-connecting member 224. The first ring 2201 is mounted on the second sub-portion 122.

As shown in FIG. 3 and FIG. 32, in an embodiment, the table portion 10 includes the first sub-portion 121, the second sub-portion 122, and the third sub-portion 123. The first sub-portion 121, the second sub-portion 122, and the third sub-portion 123 are sequentially arranged along one straight line and are aligned to each other. Each of the first sub-portion 121, the second sub-portion 122, and the third sub-portion 123 includes two splicing panels 11. At least one rotating support 22 includes a second ring 2202 with a large size. The second ring 2202 includes an annular fixing base 221, an annular rotating member 222, a plurality of rolling balls 23 and a ball-connecting member 224. The second ring 2202 connects at least the first sub-portion 121 and the third sub-portion 123.

As shown in FIG. 1 and FIG. 5, in another embodiment, the table portion 10 includes the first sub-portion 121, the second sub-portion 122, and the third sub-portion 123. The first sub-portion 121, the second sub-portion 122, and the third sub-portion 123 are sequentially arranged along one straight line and are aligned to each other. Each of the first sub-portion 121, the second sub-portion 122, and the third sub-portion 123 includes one splicing panel 11. At least one rotating support 22 includes both the first ring 2201 and the second ring 2202. The first ring 2201 and the second ring 2202 each includes the annular fixing base 221 and the annular rotating member 222. The first ring 2201 and the second ring 2202 are concentrically arranged with each other, and both the first ring 2201 and the second ring 2202 take the gravity center 102 of the table portion 10 as a center. The first ring 2201 is mounted on the second sub-portion 122, and the second ring 2202 connects the first sub-portion 121 and the third sub-portion 123.

The support structure 20 may also be provided as a combination of the roller components 21 and the rotating support 22. Referring to FIG. 1 and FIG. 4, in an embodiment, the support structure 20 includes a plurality of roller components 21 and a second ring 2202. The table portion 10 includes the first sub-portion 121, the second sub-portion 122, and the third sub-portion 123 that are distributed along one straight line. The table portion 10 also includes four roller components 21 distributed at four corners 103 of the table portion 10, that is, the roller components 21 are mounted only on the first sub-portion 121 and the third sub-portion 123, the second ring 2202 is arranged around the gravity center 102 of the table portion 10 and is connected to the first sub-portion 121 and the third sub-portion 123.

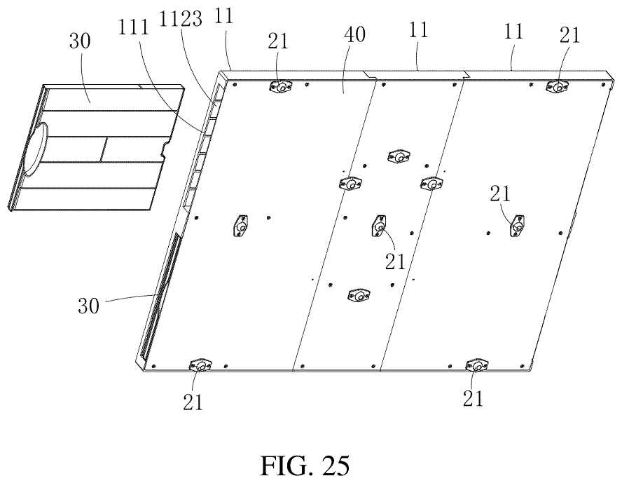

In the above embodiments, the bottom surface 101 of the table portion 10 is directly connected to the support structure 20. In other embodiments, as shown in FIGS. 25, 26, 29, 30, 33, and 34, the spliced puzzle table further includes a base plate 40. The base plate 40 is mounted on the bottom surface 101 of the table portion 10, and the support structure 20 is indirectly connected to the table portion 10 via the base plate 40. To be specific, the connection between the support structure 20 and the base plate 40 may be a mechanical connection, such as bolt fastening or adhesive bonding. Alternatively, the table portion 10 and the base plate 40 may abut against the support structure 20 by gravity of the table portion 10 and the base plate 40. The base plate 40 may include a single plate or a plurality of plates, the plurality of plates are able to be assembled into an integrated structure. In this case, the base plate 40 serves as a substitute for the sliding rail structures 1122 on the fixing bosses 112, such that the sliding rail structures 1122 can be omitted from the fixing bosses 112. Instead, the fixing boss 112, the top plate 111, and the base plate 40 together define the sliding groove 1123, guiding the drawer 30 to slide within the sliding groove 1123.

In embodiments of the spliced puzzle table that include the base plate 40, the support structure 20 can be arranged in accordance with the above embodiments. In other words, the layout of the roller components 21, the universal wheels 23, or the rotating support 22 can be arranged to be identical to the above embodiments.

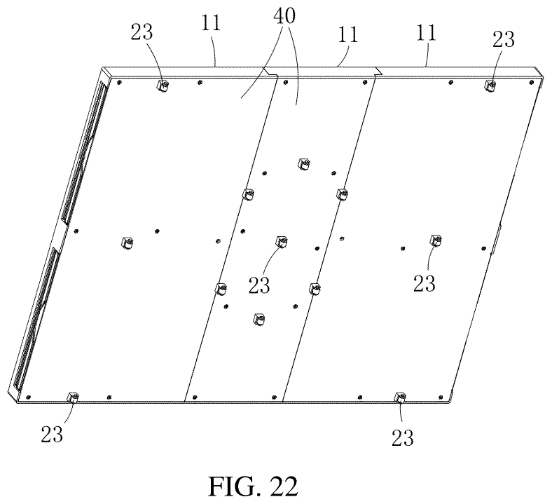

In addition, when the spliced puzzle table includes the base plate 40, if the support structure 20 includes a plurality of roller components 21 or a plurality of universal wheels 23, the roller components 21 or the universal wheels 23 can be distributed at any location of the base plate 40 instead of being positioned on the fixing bosses 112. For example, as shown in FIG. 22, the universal wheels 23 are mounted on the base plate 40.

In some embodiments, regarding the splicing structure between two adjacent splicing panels 11, as shown in FIG. 10 to FIG. 17, the spiced puzzle table includes at least one connecting assembly 50. The connecting assembly 50 connects two adjacent splicing panels 11. Each connecting assembly 50 includes a first connecting member 51 and a second connecting member 52. The first connecting member 51 is mounted on one of the two adjacent splicing panels 11, and the second connecting member 52 is mounted on the other one of the two adjacent splicing panel 11. The first connecting member 51 is inserted to the second connecting member 52 to assemble and align the two adjacent splicing panels 11 with each other.

To be specific, the first connecting member 51 and the second connecting member 52 may be integrally formed with the splicing panels 11. Alternatively, the first connecting member 51 and the second connecting member 52 may be fixed to the splicing panels 11 through splicing, bolting or other connections.

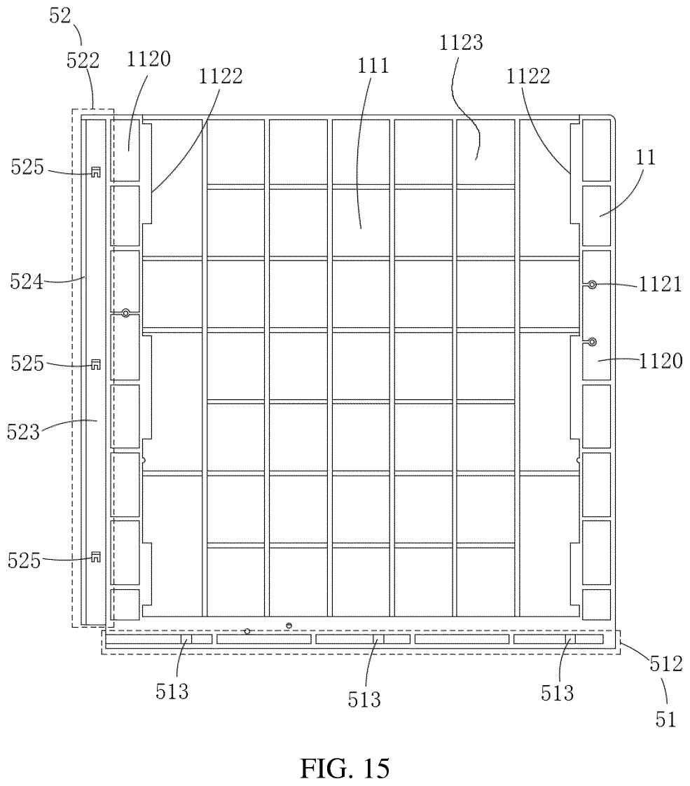

Besides, in some embodiments, as shown in FIG. 15, the first connecting member 51 or the second connecting member 52 may be formed adjacent to the fixing bosses 112. Alternatively, in other embodiments, the first connecting member 51 and second connecting member 52 may serve as the fixing bosses 112, which is not depicted in the drawings.

In an embodiment, the first connecting member 51 is an embedding platform 512, which is positioned at a side of one splicing panel 11 and integrally formed with the puzzle table. The second connecting member 52 is an embedding portion 522, which is positioned at a side of another splicing panel 11 and integrally formed with the puzzle table. The embedding portion 522 has an embedding slot 523, the embedding platform 512 can be inserted into the embedding slot 523, allowing the embedding portion 522 to be nested on the embedding platform 512, and therefore the two adjacent splicing panels 11 can be assembled together.

The connection between the embedding platform 512 and the embedding portion 522 can be achieved through interference fit or clearance fit.

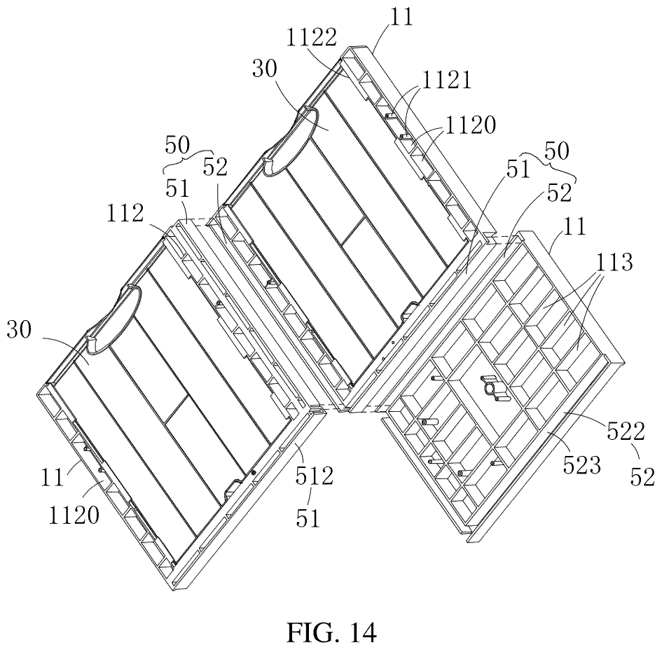

In some embodiments, the embedding portion 522 is nested on the embedding platform 512 along a direction perpendicular to the splicing panel 11. As shown in FIGS. 14, 16, and 17, the embedding platform 512 extends upwardly and is positioned below an upper surface of the splicing panel 11, while an upper surface of the embedding portion 522 is flush with the upper surface of the splicing panel 11, such that the embedding portion 522 can nested on the embedding platform 512 from top to bottom.

In some embodiments, the embedding platform 512 can be connected with the embedding portion 522 only through a friction between the embedding platform 512 and the embedding portion 522, or through a locking structure. For example, in the embodiments shown in FIGS. 15 to 17, a latching hole 513 is defined through the embedding platform 512, the latching hole 513 and the embedding slot 523 is arranged with a latching hook 525. when the embedding portion 522 is nested on the embedding platform 512, the latching hook 525 is engaged within the latching hole 513, and therefore, a connection strength between the embedding portion 522 and the embedding platform 512 can be enhanced.

In addition, an insertion seam 514 is formed between the embedding platform 512 and the splicing panel 11 which the embedding platform 512 is formed on, the embedding portion 522 includes an insertion plate 524 located on a side of the splicing panel 11 opposite to the embedding platform 512, such that the insertion plate 524 can be inserted into the insertion seam 514 via an interference fit.

Regarding the detailed structure of the roller component 21, please refer to the U.S. patent application Ser. No. 18/950,536 filed on Nov. 18, 2024. Regarding to the rotating support 22, please refer to the U.S. patent application Ser. No. 17/829,359 filed on Jun. 1, 2022, now U.S. Pat. No. 12,104,744 issued on Oct. 1, 2024.

The following embodiments are presented by combining the above content into several examples for illustration.

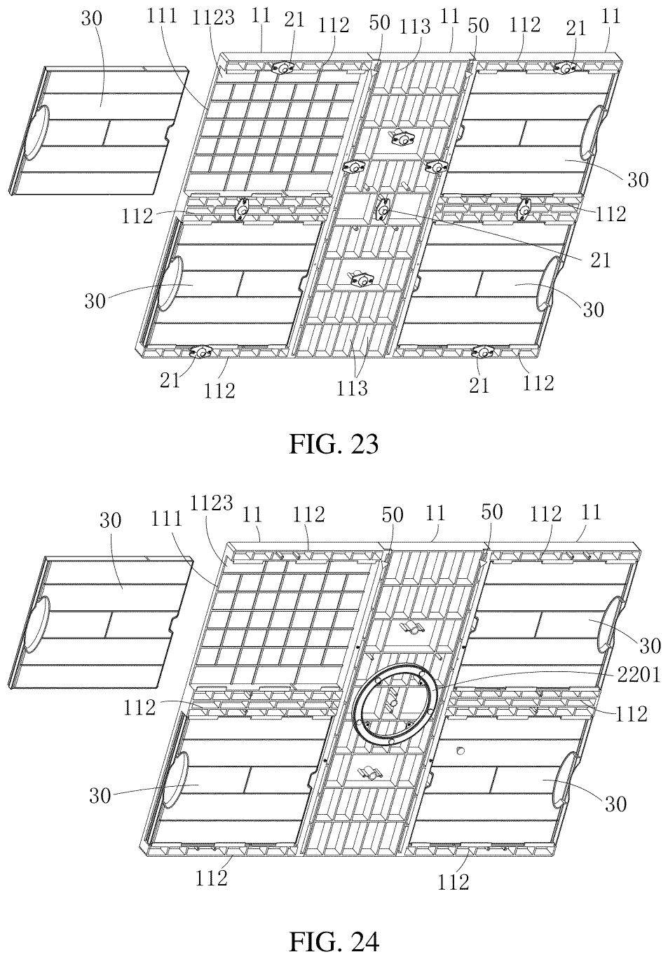

In Embodiment 1, as shown in FIG. 1, FIG. 10, and FIG. 23, the table portion 10 of the spliced puzzle table includes the first sub-portion 121, the second sub-portion 122, and the third sub-portion 123. The first sub-portion 121, second sub-portion 122, and third sub-portion 123 are arranged along one straight line, each sub-portion 12 including one splicing panel 11. Therefore, three splicing panels 11 and two connecting assemblies 50 are provided in this case. The first sub-portion 121, second sub-portion 122, and third sub-portion 123 have an equal width, the first sub-portion 121 and third sub-portion 123 have an equal length, and the length of the second sub-portion 122 is shorter than that of the first sub-portion 121. The splicing panels 11 that form the first sub-portion 121 and third sub-portion 123 each include the top plate 111 and the fixing bosses 112, with the sliding rail structure 1122 arranged on the fixing bosses 112. Each of the splicing panels 11 that form the first sub-portion 121 and third sub-portion 123 has two drawers 30. The splicing panel 11 that forms the second sub-portion 122 only includes a top plate 111, and several reinforcing ribs 113 are arranged in a crisscross layout on the bottom surface of the top plate 111. The support structure 20 includes eleven roller components 21, which are fixed to the splicing panels 11 via bolts. Four of the eleven roller components 21 are respectively positioned at each of the four corners 103 of the table portion 10, and one of the eleven roller components 21 is mounted at the gravity center 102 of the table portion 10.

In Embodiment 2, as shown in FIG. 1, FIG. 10, and FIG. 24, the table portion 10 of the spliced puzzle table includes the first sub-portion 121, the second sub-portion 122, and the third sub-portion 123. The first sub-portion 121, the second sub-portion 122, and third sub-portion 123 are configured to align along one straight line. Each sub-portion 12 includes one splicing panel 11, therefore, three splicing panels 11 and two connecting assemblies 50 are provided in this case. The first sub-portion 121, the second sub-portion 122, and the third sub-portion 123 have the equal width, the first sub-portion 121 and third sub-portion 123 have the equal length, and the length of the second sub-portion 122 is shorter than that of the first sub-portion 121. The splicing panels 11 that form the first sub-portion 121 and third sub-portion 123 each include the top plate 111 and the fixing boss 112, with a sliding rail structure 1122 arranged on the fixing boss 112. In addition, each of the splicing panels 11 that form the first sub-portion 121 and third sub-portion 123 has two drawers 30 mounted on it. The splicing panel 11 that forms the second sub-portion 122 only includes a top plate 111, and several reinforcing ribs 113 are arranged in a crisscross layout on the bottom surface of the top plate 111. The support structure 20 includes the first ring 2201, which is connected to the second sub-portion 122 by bolts.

In Embodiment 3, as shown in FIG. 1, FIG. 10, and FIG. 25, the table portion 10 of the spliced puzzle table is substantially the same as that of Embodiment 1. Therefore, the table portion 10 also includes three splicing panels 11 and two connecting assemblies 50. A base plate 40 is mounted on the bottom surface 101 of the table portion 10, and the base plate 40 is connected to the first sub-portion 121, the second sub-portion 122, and the third sub-portion 123 via bolts. A sliding groove 1123 is formed among the base plate 40, the fixing bosses 112, and the top plate 111 (it should be clarified that the sliding rail structures 1122 can still be arranged on the fixing bosses 112). The support structure 20 includes eleven roller components 21. The arrangement of the roller components 21 in this embodiment is substantially the same as in Embodiment 1. The only difference is that, in this embodiment, the roller components 21 are spaced apart from the table portion 10 by the base plate 40.

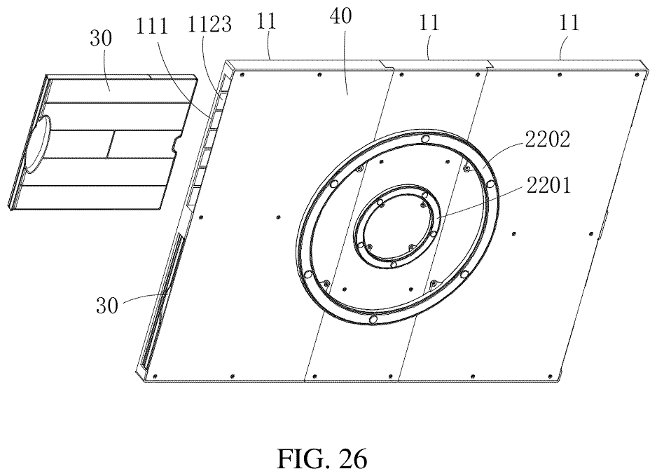

In Embodiment 4, as shown in FIG. 1, FIG. 10, and FIG. 26, the table portion 10 of the spliced puzzle table is substantially the same as in Embodiment 2. Therefore, the table portion 10 also includes three splicing panels 11 and two connecting assemblies 50. A base plate 40 is mounted on the bottom surface 101 of the table portion 10. The base plate 40 is connected to the first sub-portion 121, the second sub-portion 122, and the third sub-portion 123 by bolts. A sliding groove 1123 is formed among the base plate 40, the fixing bosses 112, and the top plate 111 (it should be noted that the sliding rail structures 1122 can still be arranged on the fixing bosses 112). The support structure 20 includes the first ring 2201 and the second ring 2202 arranged concentrically with the first ring 2201. Both the first ring 2201 and the second ring 2202 are located beneath the base plate 40. At least one screw penetrates the base plate 40 to connect the first ring 2201 with the second sub-portion 122, and at least one screw also penetrates the base plate 40 to connect the second ring 2202 with both the first sub-portion 121 and the third sub-portion 123.

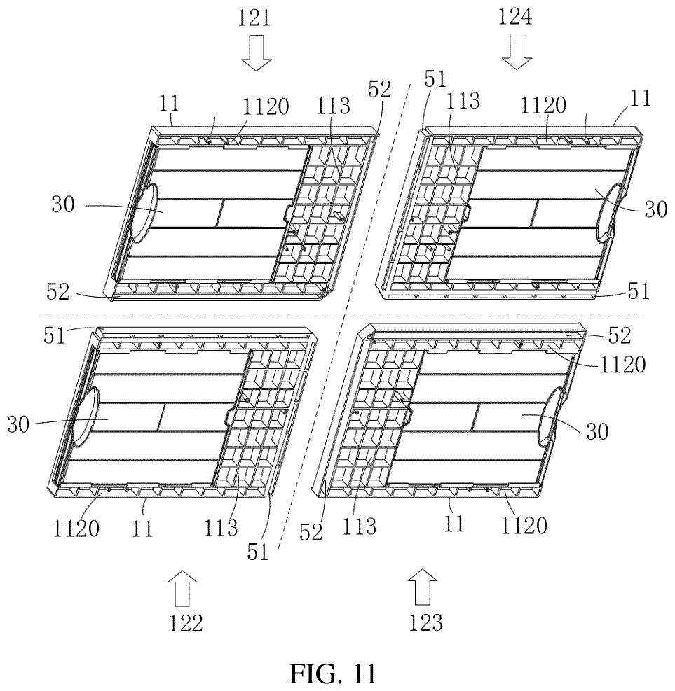

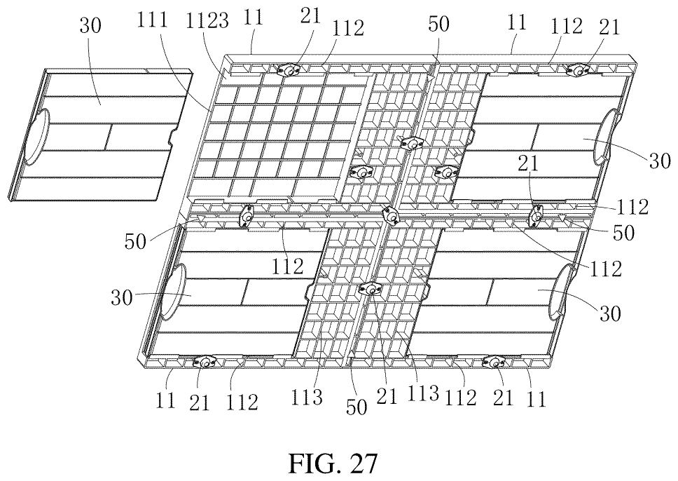

In Embodiment 5, as shown in FIG. 2, FIG. 11, and FIG. 27, the table portion 10 of the spliced puzzle table includes the first sub-portion 121, the second sub-portion 122, the third sub-portion 123, and the fourth sub-portion 124. The first sub-portion 121, the second sub-portion 122, the third sub-portion 123, and the fourth sub-portion 124 are arranged in a square layout around the gravity center 102 of the table portion 10. Each sub-portion 12 includes one splicing panel 11. Therefore, in this case, the table portion 10 includes four splicing panels 11 and four connecting assemblies 50. The first sub-portion 121 and the third sub-portion 123 are arranged in central symmetry, and the second sub-portion 122 and the fourth sub-portion 124 are also arranged in central symmetry. Each of the splicing panels 11 forming the sub-portions 12 includes a top plate 111 and fixing bosses 112, with sliding rail structures 1122 arranged on the fixing bosses 112. Each of the sub-portions 12 is provided with a drawer 30, and several reinforcing ribs 113 are arranged in a crisscross layout on the bottom surface of each top plate 111, excluding the area where the sliding grooves 1123 are located. The support structure 20 includes eleven roller components 21. The roller components 21 are fixed to the splicing panels 11 by bolts. Among the eleven roller components 21, four roller components 21 are respectively positioned at the four corners 103 of the table portion 10, the splicing panels 11 of two adjacent sub-portions 12 are connected with each other via the four roller components 21, and one of the four roller components 21 is mounted at the gravity center 102 of the table portion 10.

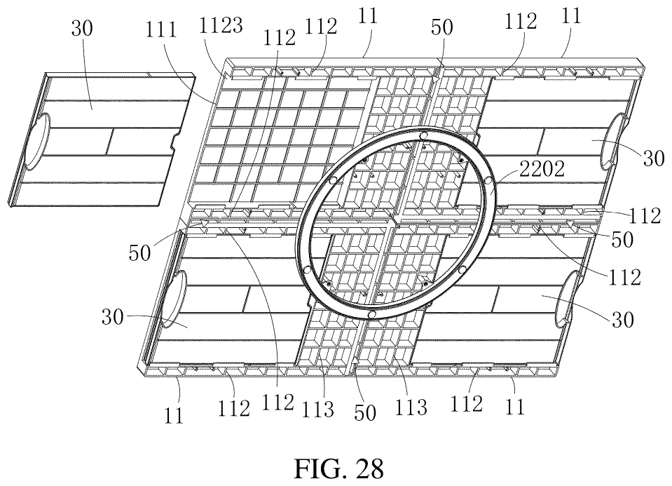

In Embodiment 6, as shown in FIG. 2, FIG. 11, and FIG. 28, the table portion 10 of the spliced puzzle table includes the first sub-portion 121, the second sub-portion 122, the third sub-portion 123, and the fourth sub-portion 124. The first sub-portion 121, the second sub-portion 122, the third sub-portion 123, and the fourth sub-portion 124 are arranged in a square layout around the gravity center 102 of the table portion 10. Each sub-portion 12 includes one splicing panel 11. Therefore, in this case, the table portion 10 includes four splicing panels 11 and four connecting assemblies 50. The first sub-portion 121 and the third sub-portion 123 are arranged in central symmetry, and the second sub-portion 122 and the fourth sub-portion 124 are also arranged in central symmetry. Each of the splicing panels 11 forming the sub-portions 12 includes a top plate 111 and fixing bosses 112, with sliding rail structures 1122 arranged on the fixing bosses 112. Each of the sub-portions 12 is provided with a drawer 30, and several reinforcing ribs 113 are arranged in a crisscross layout on the bottom surface of each top plate 111, excluding the area where the sliding grooves 1123 are located. The support structure 20 includes the second ring 2202, and the second ring 2202 is connected to all of the sub-portions 12 by bolts.

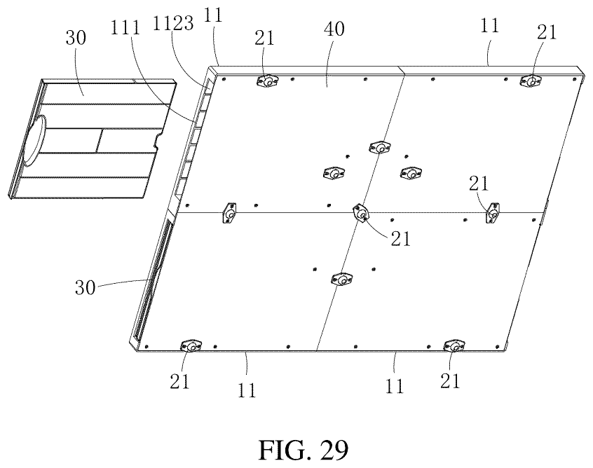

In Embodiment 7, as shown in FIG. 2, FIG. 11, and FIG. 29, the table portion 10 of the spliced puzzle table is substantially the same as in Embodiment 5. Therefore, in this case, the table portion 10 includes four splicing panels 11 and four connecting assemblies 50. A base plate 40 is mounted on the bottom surface 101 of the table portion 10. The base plate 40 is connected to the first sub-portion 121, the second sub-portion 122, the third sub-portion 123, and the fourth sub-portion 124 by bolts. A sliding groove 1123 is formed among the base plate 40, the fixing bosses 112, and the top plate 111 (it should be noted that the sliding rail structures 1122 can still be arranged on the fixing bosses 112). The support structure 20 includes eleven roller components 21. The arrangement of the roller components 21 in this embodiment is substantially the same as in Embodiment 5. The only difference is that, the roller components 21 in this embodiment are spaced apart from the table portion 10 by the base plate 40.

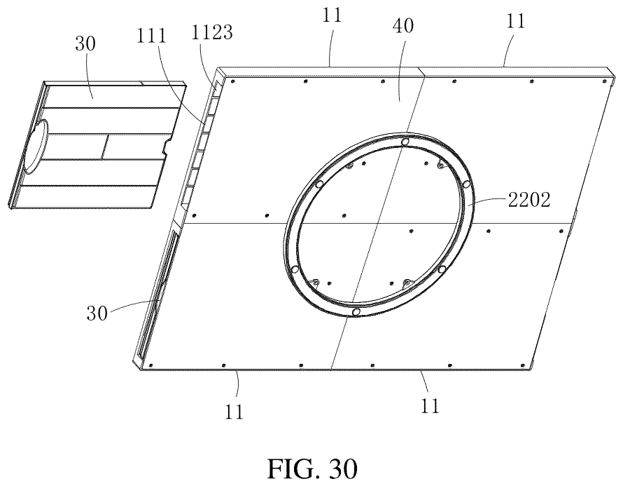

In Embodiment 8, as shown in FIG. 2, FIG. 11, and FIG. 30, the table portion 10 of the spliced puzzle table is substantially the same as in Embodiment 6. Therefore, in this case, the table portion 10 includes four splicing panels 11 and four connecting assemblies 50. A base plate 40 is mounted on the bottom surface 101 of the table portion 10. The base plate 40 is connected to the first sub-portion 121, the second sub-portion 122, the third sub-portion 123, and the fourth sub-portion 124 by bolts. A sliding groove 1123 is formed among the base plate 40, the fixing bosses 112, and the top plate 111 (it should be noted that the sliding rail structures 1122 can still be arranged on the fixing bosses 112). The support structure 20 includes the second ring 2202. The second ring 2202 is connected to all of the sub-portions 12 by bolts penetrating the base plate 40.

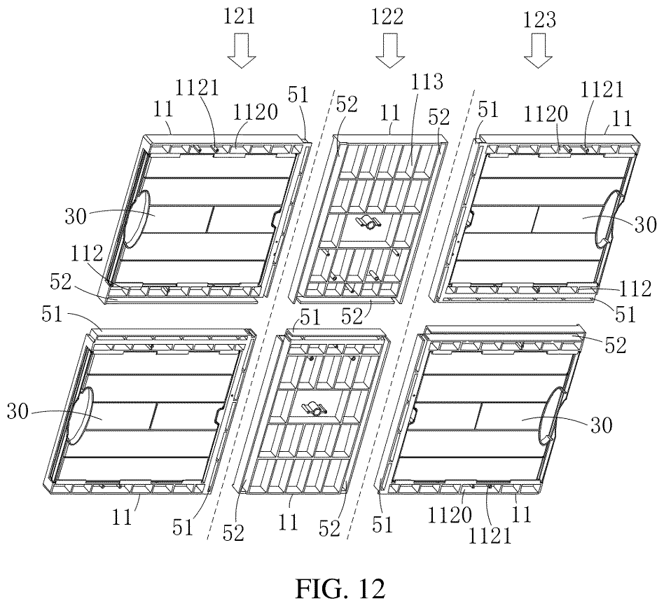

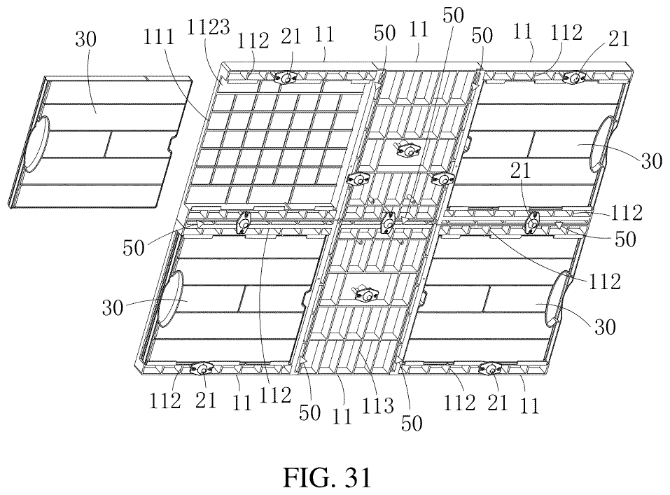

In Embodiment 9, as shown in FIG. 3, FIG. 12, and FIG. 31, the table portion 10 of the spliced puzzle table includes the first sub-portion 121, the second sub-portion 122, and the third sub-portion 123. The first sub-portion 121, the second sub-portion 122, and the third sub-portion 123 are arranged along one straight line. Each of the sub-portions 12 includes two splicing panels 11. Therefore, in this case, the table portion 10 includes six splicing panels 11 and seven connecting assemblies 50. The first sub-portion 121, the second sub-portion 122, and the third sub-portion 123 have the equal width. The first sub-portion 121 and the third sub-portion 123 have the equal length, and the length of the second sub-portion 122 is shorter than that of the first sub-portion 121. The first sub-portion 121 and the third sub-portion 123 are arranged in central symmetry (the two splicing panels 11 forming the first sub-portion 121 and the two splicing panels 11 forming the third sub-portion 123 are also arranged in central symmetry). Each of the splicing panels 11 forming the first sub-portion 121 and the third sub-portion 123 includes a top plate 111 and a fixing boss 112, with sliding rail structures 1122 arranged on the fixing bosses 112. Each of the splicing panels 11 forming the first sub-portion 121 and the third sub-portion 123 is arranged with a drawer 30. Each of the two splicing panels 11 forming the second sub-portion 122 only includes the top plate 111, and several reinforcing ribs 113 are arranged in a crisscross layout on the bottom surface of the top plate 111. The support structure 20 includes eleven roller components 21. The roller components 21 are fixed to the splicing panels 11 by bolts. Among the eleven roller components 21, four roller components 21 are respectively positioned at the four corners 103 of the table portion 10, five roller components 21 are provided to connect adjacent splicing panels 11 of two adjacent sub-portions 12, and one of the five roller components 21 is mounted at the gravity center 102 of the table portion 10.

In Embodiment 10, as shown in FIG. 3, FIG. 12, and FIG. 32, the table portion 10 of the spliced puzzle table includes the first sub-portion 121, the second sub-portion 122, and the third sub-portion 123. The first sub-portion 121, the second sub-portion 122, and the third sub-portion 123 are arranged along one straight line. Each of the sub-portions 12 includes two splicing panels 11. Therefore, in this case, the table portion 10 includes six splicing panels 11 and seven connecting assemblies 50. The first sub-portion 121, the second sub-portion 122, and the third sub-portion 123 have the equal width. The first sub-portion 121 and the third sub-portion 123 have the equal length, and the length of the second sub-portion 122 is shorter than that of the first sub-portion 121. The first sub-portion 121 and the third sub-portion 123 are arranged in central symmetry (the two splicing panels 11 forming the first sub-portion 121 and the two splicing panels 11 forming the third sub-portion 123 are also arranged in central symmetry). Each of the splicing panels 11 forming the first sub-portion 121 and the third sub-portion 123 includes a top plate 111 and a fixing boss 112, with sliding rail structures 1122 arranged on the fixing bosses 112. A drawer 30 is mounted on each of the splicing panels 11 forming the first sub-portion 121 and the third sub-portion 123. Each of the two splicing panels 11 forming the second sub-portion 122 only includes the top plate 111, and several reinforcing ribs 113 are arranged in a crisscross layout on the bottom surface of the top plate 111. The support structure 20 includes the second ring 2202. The second ring 2202 is connected to two splicing panels 11 forming the first sub-portion 121 and two splicing panels 11 forming the third sub-portion 123 by bolts.

In Embodiment 11, as shown in FIG. 3, FIG. 12, and FIG. 33, the table portion 10 of the spliced puzzle table is substantially the same as that in Embodiment 9. Therefore, in this case, the table portion 10 includes six splicing panels 11 and seven connecting assemblies 50. A base plate 40 is mounted on the bottom surface 101 of the table portion 10. The base plate 40 is connected to all the splicing panels 11 of the first sub-portion 121, the second sub-portion 122, and the third sub-portion 123 by bolts. A sliding groove 1123 is formed among the base plate 40, the fixing bosses 112, and the top plates 111 (it should be noted that the sliding rail structures 1122 can still be arranged on the fixing bosses 112). The support structure 20 includes eleven roller components 21. The arrangement of the roller components 21 in this embodiment is substantially the same as that in Embodiment 9. The only difference is that, in this embodiment, the roller components 21 are spaced apart from the table portion 10 by the base plate 40.

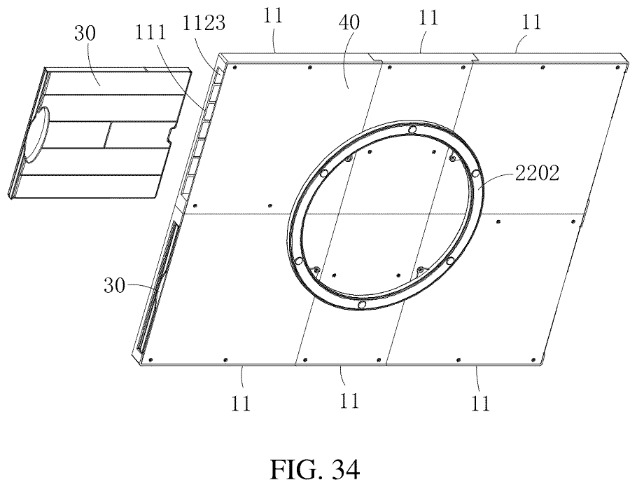

In Embodiment 12, as shown in FIG. 3, FIG. 12, and FIG. 34, the table portion 10 of the spliced puzzle table is substantially the same as that in Embodiment 10. Therefore, in this case, the table portion 10 includes six splicing panels 11 and seven connecting assemblies 50. A base plate 40 is mounted on the bottom surface 101 of the table portion 10. The base plate 40 is connected to all the splicing panels 11 of the first sub-portion 121, the second sub-portion 122, and the third sub-portion 123 by bolts. A sliding groove 1123 is formed among the base plate 40, the fixing bosses 112, and the top plates 111 (it should be noted that the sliding rail structures 1122 can still be arranged on the fixing bosses 112). The support structure 20 includes the second ring 2202. The second ring 2202 penetrates the base plate 40 and is connected to two splicing panels 11 of the first sub-portion 121 and two splicing panels 11 of the third sub-portion 123 by bolts.

Obviously, the embodiments described above are only a part of the embodiments of the present disclosure, and not all of them. The accompanying drawings give some embodiments of the present disclosure, but do not limit the patentable scope of the disclosure, which may be realized in many different forms. Rather, these embodiments are provided for the purpose of providing a more thorough and comprehensive understanding of the present disclosure. Although the present disclosure has been described in detail with reference to the foregoing embodiments, it is still possible for a person skilled in the art to modify the technical solutions recorded in the foregoing specific embodiments or to make equivalent substitutions for some of the technical features therein. Any equivalent structure made by utilizing the contents of the specification and the accompanying drawings of the present disclosure, directly or indirectly applied in other related technical fields, are all the same within the scope of the patent protection of the present disclosure.

What is claimed is:

1. A spliced puzzle table, comprises:
a table portion, wherein the table portion comprises at least two splicing panels, the at least two splicing panels are configured to be spliced together on a plane;
a support structure, wherein the support structure is disposed on a bottom surface of the table portion and is configured to enable the table portion to rotate or move.

2. The spliced puzzle table according to claim 1, wherein the support structure substantially surrounds a gravity center of the table portion, the support structure and the bottom surface of the table portion are connected with each other via at least one of adhesive bonding, snap, fit connection, magnetic attraction, bolted connection, or pinned connection.

3. The spliced puzzle table according to claim 1, wherein the table portion comprises at least three sub-portions, the at least three sub-portions are configured to be aligned to each other along one straight line, each sub-portion of the at least three sub-portions comprises at least one splicing panel of the at least two splicing panels, and an orthographic projection of the support structure is partially or fully located in at least one sub-portion.

4. The spliced puzzle table according to claim 3, wherein the orthographic projection of the support structure extends across at least two sub-portions and is located on the at least two sub-portions, each sub-portion comprises one splicing panel or two splicing panels of the at least two splicing panels.

5. The spliced puzzle table according to claim 1, wherein the table portion comprises at least three sub-portions, the at least three sub-portions surround a gravity center of the table portion, each sub-portion of the at least three sub-portions comprises at least one splicing panel of the at least two splicing panels.

6. The spliced puzzle table according to claim 5, wherein the number of the at least three sub-portions is four, each sub-portion comprises one splicing panel, and an orthographic projection of the support structure locates on four splicing panels.

7. The spliced puzzle table according to claim 1,
wherein the support structure comprises a plurality of roller components, each roller component comprises a mounting base and a ball mounted on the mounting base, and the ball is capable of rolling within the mounting base, the mounting base of the roller component is fixedly connected to the bottom surface of the table portion, at least one of the plurality of roller components is mounted at an edge of the at least one splicing panel;
wherein at least one splicing panel of the at least two splicing panels is arranged with a drawer, and the plurality of roller components are arranged to out of an area in which the drawer is capable of moving.

8. The spliced puzzle table according to claim 7,
wherein each splicing panel of the at least two splicing panels comprises a top plate and at least two fixing bosses, the at least two fixing bosses is formed below an edge of the top plate, the drawer is mounted between two of the at least two fixing bosses; when the at least two splicing panels are spliced together, the at least two splicing panels are aligned to each other;
wherein at least one roller component of the plurality of roller components is mounted on the at least two bosses of the splicing panel.

9. The spliced puzzle table according to claim 7, wherein a hollow slot is defined at a bottom of a fixing boss, a connecting post is arranged inside the hollow slot, and the connecting post is connected with the mounting base through a bolt or a pin.

10. The spliced puzzle table according to claim 7,
wherein the table portion is configured as a rectangular structure with four corners, at least four roller components of the plurality of roller components are respectively positioned at the four corners of the table portion, at least one mounting base connects two splicing panels of the at least two splicing panels that are adjacent to each other.

11. The spliced puzzle table according to claim 1, wherein the support structure comprises at least one rotating support, each rotating support comprises a fixing base and a rotating member, the rotating member is capable of rotating relative to the fixing base, the fixing base of the rotating support is fixed to the bottom surface of the table portion.

12. The spliced puzzle table according to claim 11, wherein the table portion comprises a first sub-portion, a second sub-portion and a third sub-portion, the first sub-portion, the second sub-portion and the third sub-portion are sequentially positioned and aligned to each other along one straight line, each of the first sub-portion, the second sub-portion and the third sub-portion comprises at least one of the at least two splicing panels;
each of the at least one rotating support comprises a first ring, the first ring is mounted on the second sub-portion.

13. The spliced puzzle table according to claim 11, wherein each of the at least one rotating supports comprises a second ring, the second ring is connected with at least two splicing panels.

14. The spliced puzzle table according to claim 11, wherein the table portion comprises a first sub-portion, a second sub-portion and a third sub-portion, the first sub-portion, the second sub-portion and the third sub-portion are sequentially positioned along one straight line, each of the first sub-portion, the second sub-portion and the third sub-portion comprises at least one of the at least two splicing panels;
each of the at least one rotating support comprises a first ring and a second ring, the first ring is mounted on the second sub-portion, and the second ring is connected to at least the first sub-portion and the third sub-portion.

15. The spliced puzzle table according to claim 1, wherein the support structure comprises a plurality of roller components and at least one rotating support, each roller component of the plurality of roller components comprises a mounting base and a ball mounted on the mounting base, the ball is capable of rolling within the mounting base, the mounting base of the roller component is fixedly connected to the bottom surface of the table portion;
wherein the rotating support comprises a fixing base and a rotating member that rotates relative to the fixing base, the fixing base of the rotating support is fixed connected to the bottom surface of the table portion.

16. The spliced puzzle table according to claim 1, further comprising a base plate, wherein the base plate is connected to the bottom surface of the table portion, the support structure is assembled to the table portion via the base plate, the support structure and the base plate are connected with each other via one of mechanical connections or weighted abutment;
wherein the support structure comprises a plurality of roller components and at least one rotating support, the plurality of roller components are positioned at any location on the base plate, each rotating support is configured to substantially surround a gravity center of the table portion.

17. The spliced puzzle table according to claim 1, further comprising at least one connecting assembly, wherein each connecting assembly is configured to connect two splicing panels of the at least two splicing panels that are adjacent to each other;
wherein each connecting assembly comprises a first connecting member and a second connecting member, the first connecting member is mounted on one of the two splicing panels that are adjacent to each other, the second connecting member is mounted on the other one of the two adjacent splicing panels that are adjacent to each other, the first connecting member is inserted to the second connecting member to assemble and align the two splicing panels that are adjacent to each other.

18. The spliced puzzle table according to claim 17, wherein the first connecting member is an embedding platform, the embedding platform is mounted on one of the two splicing panels that are adjacent to each other;
wherein the second connecting member is an embedding portion, the embedding portion is mounted on the other one of the two splicing panels that are adjacent to each other, an embedding slot is defined on the embedding portion, when the embedding platform is inserted into the embedding slot, the embedding portion is nested on the embedding platform.

19. The spliced puzzle table according to claim 18, wherein the embedding portion is nested on the embedding platform along a direction perpendicular to the splicing panel.

20. The spliced puzzle table according to claim 18, wherein a latching hole is defined through the embedding platform, and a latching hook is arranged within the embedding slot, when the embedding portion is nested on the embedding platform, the latching hook is engaged within the latching hole.
